(19) United States
(12) Patent Application Publication
(10) Pub. No.: US 2011/0216359 A1
(43) Pub. Date: Sep. 8, 2011

(54) MAINTENANCE SCHEDULING SYSTEM AND MAINTENANCE SCHEDULE CREATING METHOD

(75) Inventors: Yoshikatsu Kamisuwa, Tokyo-to (JP); Hiroyo Katou, Shizuoka-ken (JP)

(73) Assignees: KABUSHIKI KAISHA TOSHIBA, Minato-ku (JP); TOSHIBA TEC KABUSHIKI KAISHA, Tokyo (JP)

(21) Appl. No.: 13/037,570

(22) Filed: Mar. 1, 2011

Related U.S. Application Data
(60) Provisional application No. 61/309,937, filed on Mar. 3, 2010.

(51) Int. Cl. G06F 3/12

(52) U.S. Cl. 358/1.15

(57) ABSTRACT

According to one embodiment, a management apparatus includes a setting unit, a data converting unit, and a maintenance scheduling unit. The setting unit sets a relation value indicating a relation between the number of operations in an image processing apparatus to be subjected to maintenance scheduling and data indicating the live of a consumable in the image processing apparatus. The data converting unit converts, using the relation value, the number of operations acquired from the image processing apparatus into the data indicating the life of the consumable in the image processing apparatus. The maintenance scheduling unit creates a maintenance schedule for the image processing apparatus using the data indicating the life of the consumable in the image processing apparatus calculated by the data converting unit.

### CROSS-REFERENCE TO RELATED APPLICATIONS

This application is based upon and claims the benefit of priority from U.S. Provisional Application No. 61/309,937 filed on Mar. 3, 2010; the entire contents of which are incorporated herein by reference.

### FIELD

Embodiments described herein relate generally to a management apparatus, a maintenance scheduling system, and a maintenance schedule creating method for creating a maintenance schedule for an image processing apparatus.

### BACKGROUND

A maintenance schedule for an image processing apparatus such as a digital multifunction peripheral is worked out by estimating failure periods of the product including plural components, deterioration degrees of the components, and the like. In the past, a maintenance schedule for an image processing apparatus is often created by man power relying on experiences and intuitions of a serviceperson. Therefore, it is difficult to balance a risk of a user due to unavailability of the apparatus and cost for maintenance. The image processing apparatus such as the digital multifunction peripheral is often operated in various forms. Therefore, for a management apparatus that provides maintenance services for plural image processing apparatuses, it is difficult to efficiently work out maintenance schedules according to operation forms of the image processing apparatuses.

### BRIEF DESCRIPTION OF THE DRAWINGS

FIG. 1 is a schematic diagram of a maintenance scheduling system;

FIG. 2 is a sectional view of a configuration example of a MFP;

FIG. 3 is a block diagram of a configuration example of a control system in the MFP;

FIG. 4 is a diagram of configuration examples of the maintenance scheduling system and a management apparatus;

FIG. 5 is a schematic diagram for explaining processing for creating a maintenance schedule for a first MFP;

FIGS. 6A and 6B are diagrams for explaining a relation between formats of data used in the maintenance scheduling system and data tables;

FIG. 7 is a diagram of information stored in a state information table of the MFP;

FIG. 8 is a diagram of an example of a maintenance history table;

FIG. 9 is a diagram of an example of a consumables table;

FIG. 10 is a diagram of an example of a life counter history table;

FIG. 11 is a diagram of an example of a machine table;

FIG. 12 is a diagram of an example of data of a consumables state table;

FIG. 13 is a diagram of an example of a user and machine correspondence table;

FIG. 14 is a flowchart for explaining processing for calculating a visit interval and a replacement interval;

FIG. 15 is a diagram of a relation between the visit interval and cost;

FIG. 16 is a diagram of an example of a “visit interval lower limit” and a “visit interval upper limit” corresponding to a tolerance for cost;

FIG. 17 is a diagram of a relation between the replacement interval and the cost;

FIG. 18 is a diagram of an example of information stored by the MFP;

FIG. 19 is a flowchart for explaining a processing procedure in a “visit day presentation mode”;

FIG. 20 is a diagram of an example of a visit schedule table;

FIG. 21 is a diagram of a display example a list of visit scheduled days displayed as a processing result in the “visit day presentation mode”;

FIG. 22 is a diagram of a display example of visit scheduled days displayed on a calendar as a processing result in the “visit day presentation mode”;

FIG. 23 is a diagram of an output example of detailed contents of maintenance work for users displayed as a processing result in the “visit day presentation mode”;

FIG. 24 is a schematic diagram for explaining processing for creating a maintenance schedule for a second MFP;

FIG. 25 is a diagram of a relation between a total counter value and a life counter value;

FIG. 26 is a diagram of an example of acquired data (spot collection data) acquired by a serviceperson;

FIG. 27 is a flowchart for explaining a flow of the processing for creating a maintenance schedule for the second MFP;

FIG. 28 is a schematic diagram for explaining processing for creating a maintenance schedule for a third MFP;

FIG. 29 is a diagram of transition of total counter values; and

FIG. 30 is a flowchart for explaining a flow of the processing for creating a maintenance schedule for the third MFP.

### DETAILED DESCRIPTION

In general, according to one embodiment, a management apparatus includes a setting unit, a data converting unit, and a maintenance scheduling unit. The setting unit sets a relation value indicating a relation between the number of operations in an image processing apparatus to be subjected to maintenance scheduling and data indicating the life of a consumable in the image processing apparatus. The data converting unit converts, using the relation value, the number of operations acquired from the image processing apparatus into the data indicating the life of the consumable in the image processing apparatus. The maintenance scheduling unit creates a maintenance schedule for the image processing apparatus using the data indicating the life of the consumable in the image processing apparatus calculated by the data converting unit.

Embodiments are explained in detail below with reference to the accompanying drawings.

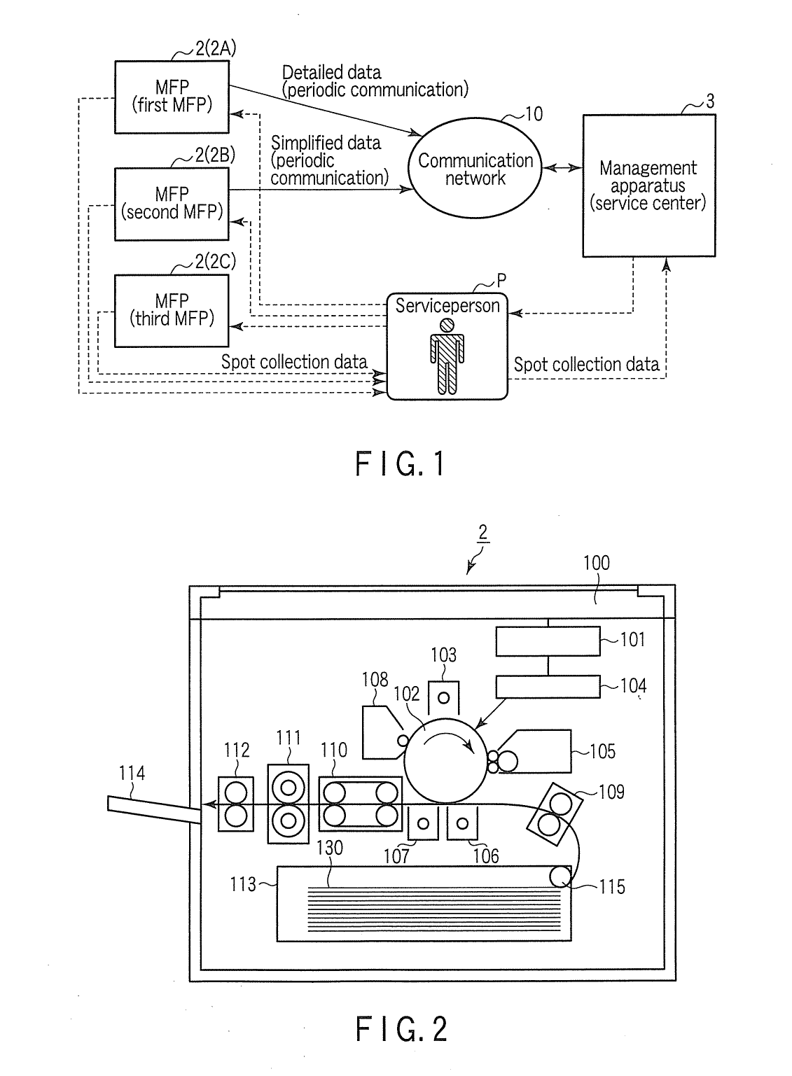

FIG. 1 is a schematic diagram of a maintenance scheduling system for an image processing apparatus according to an embodiment.

The maintenance scheduling system shown in FIG. 1 includes plural digital multifunction peripherals (MFPs) 2 functioning as image processing apparatuses (image forming apparatuses) and a management apparatus 3. Each of the digital multifunction peripheral 2 includes a copier, a scanner, a printer, and various data communication functions. The digital multifunction peripheral 2 only has to be an apparatus that performs image processing and may be, for example, a copying machine including only a copying function. The digital multifunction peripheral 2 may be an apparatus including a function of only the scanner or the printer. The management apparatus 3 includes a function of creating maintenance schedules for the digital multifunction peripherals 2 in the system.

The digital multifunction peripherals 2 are operated in various forms (purposes of use, setting environments, setting conditions, etc.). For example, in some case, in the digital multifunction peripherals 2, an amount of data communication by a data communication function is limited or the data communication function is stopped or omitted according to an operation form. The maintenance scheduling system shown in FIG. 1 includes the digital multifunction peripheral 2 configured to periodically transmit detailed data to the management apparatus 3 via a communication network 10 using the data communication function, the digital multifunction peripheral 2 configured to periodically transmit only simplified data to the management apparatus 3 via the communication network 10 using the data communication function, and the digital multifunction peripheral 2 configured not to perform data transmission via the communication network 10 by the data communication function.

In this embodiment, the digital multifunction peripheral 2 configured to periodically transmit detailed data to the management apparatus 3 is classified as a first digital multifunction peripheral 2A, the digital multifunction peripheral 2 configured to periodically transmit simplified data to the management apparatus 3 is classified as a second digital multifunction peripheral 2B, and the digital multifunction peripheral 2 configured not to perform periodical data transmission to the management apparatus 3 is classified as a third digital multifunction peripheral 2C.

The management apparatus 3 creates, for the first digital multifunction peripheral 2A, a maintenance schedule according to the detailed data periodically acquired via the communication network 10. The management apparatus 3 creates, for the second digital multifunction peripheral 2B, a maintenance schedule according to the simplified data periodically acquired from the communication network 10 and data estimated from the simplified data. The management apparatus 3 creates, for the third digital multifunction peripheral 2C, a maintenance schedule according to data (spot collection data) acquired from the third digital multifunction peripheral 2C by human work. In other words, the management apparatus 3 includes a function of creating maintenance schedules for the digital multifunction peripherals operated in the various forms.

The configuration of the digital multifunction peripheral (MFP) 2 as an image processing apparatus to be subjected to maintenance according to a maintenance schedule is explained below.

FIG. 2 is a diagram of the configuration in the MFP 2.

The MFP 2 includes a scanner 100, a control unit 101, a photoconductive drum 102, a charging device 103, a scanning exposure unit 104, a developing device 105, a transfer charger 106, a peeling charger 107, a cleaner 108, a paper feeding unit 109, a sheet conveying unit 110, a fixing device 111, a paper discharge unit 112, and a paper discharge tray 114. The photoconductive drum 102, the charging device 103, the scanning exposure unit 104, the developing device 105, the transfer charger 106, the peeling charger 107, the cleaner 108, the paper feeding unit 109, the sheet conveying unit 110, the fixing device 111, the paper discharge unit 112, and the paper discharge tray 114 configure a printer 120.

The scanner 100 optically reads an image of an original document and acquires image data. The scanner 100 outputs the read image data to the control unit 101. The control unit 101 controls the units of the printer 120. When the original document is copied, the control unit 101 controls the units of the printer 120 according to the image data of the original document read by the scanner 100 to thereby form (print) the image of the original document on a sheet used as an image formation medium.

The photoconductive drum 102 rotates in a sub-scanning direction (the circumferential direction of the photoconductive drum 102). The charging device 103 is arranged near the photoconductive drum 102. The charging device 103 uniformly charges the surface of the photoconductive drum 102. The scanning exposure unit 104 emits light and extinguishes the light according to an image signal while scanning a semiconductor laser in the scanning exposure unit 104. A laser beam emitted from the semiconductor laser is changed to light for scanning in a main scanning direction (the rotation axis direction of the photoconductive drum 102) by a deflector such as a polygon mirror. The laser beam is irradiated on the photoconductive drum 102 by an optical system such as a lens. If the laser beam is irradiated on the charged photoconductive drum 102, the potential of an irradiated region drops and an electrostatic latent image is formed.

The developing device 105 applies a developer to the photoconductive drum 102 to form a toner image on the photoconductive drum 102. A sheet tray 113 is provided at the bottom of the MFP 2. A paper feeding roller 115 separates sheets 130 in the sheet tray 113 one by one and delivers the sheet 130 to the paper feeding unit 109. The paper feeding unit 109 feeds the sheet 130 to a transfer position of the photoconductive drum 102. The transfer charger 106 transfers the toner image onto the fed sheet 130. The peeling charger 107 peels the sheet 130 off the photoconductive drum 102.

The sheet 130 having the toner image transferred thereon is conveyed by the sheet conveying unit 110. The fixing device 111 fixes the toner image on the sheet 130. The paper discharge unit 112 discharges the sheet 130 having an image printed thereon to the paper discharge tray 114.

After the transfer of the toner image onto the sheet 130 ends, a residual toner on the photoconductive drum 102 is removed by the cleaner 108. The photoconductive drum 102 returns to an initial state and stays on standby for the next image formation.

An image forming operation is continuously performed by repeating the process operation explained above.

The configuration of a control system in the MFP 2 is explained below.

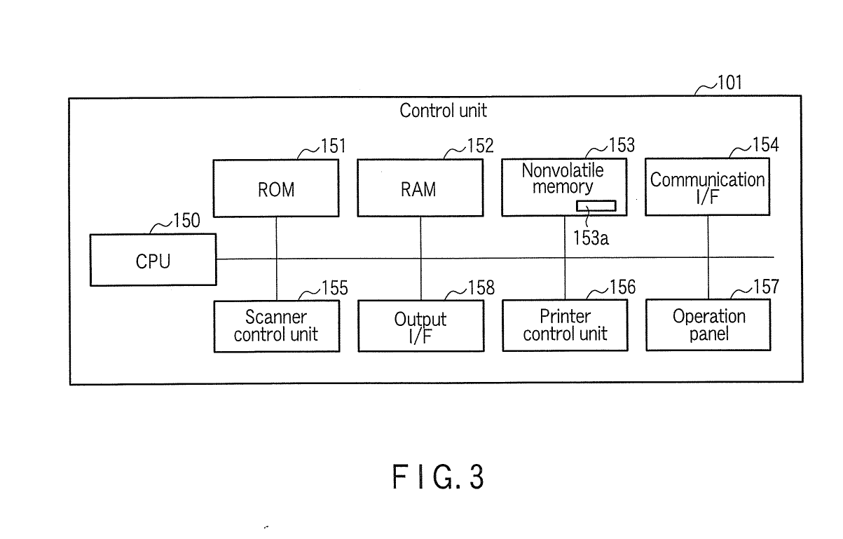

FIG. 3 is a block diagram of a configuration example of the control unit 101 in the MFP 2.

The control unit 101 includes a CPU (a processor) 150, a ROM 151, a RAM 152, a nonvolatile memory 153, a communication interface 154, a scanner control unit 155, a printer control unit 156, an operation panel 157, and an output interface 158.

The CPU 150 is, for example, a processor. The CPU 150 manages the control of the entire MFP 2. The CPU 150 executes various kinds of processing by executing computer programs stored in the ROM 151 or the nonvolatile memory 153. The ROM 151 stores a control program, control data, and the like. The RAM 152 is used as a working memory or a buffer memory. The nonvolatile memory 153 is a rewritable nonvolatile memory. The nonvolatile memory 153 stores the control program, the control data, and the like.

The nonvolatile memory 153 includes a state information table 153a configured to store values indicating states of use of the MFP 2. The state information table 153a stores data used as detailed data or simplified data. For example, the state information table 153a stores total counter values indicating the numbers of times of operation (use) of the entire MFP and consumables of the MFP. The state information table 153a stores life counter values for determining the lives for the consumables. Further, the nonvolatile memory 153 stores, for example, values detected by sensors provided in the MFP 2.

The state information table 153a stores a total number of printed sheets as a total counter value. The state information table 153a may store a counter value obtained by counting the number of prints in each of print modes (color print, monochrome print, etc.). The state information table 153a may store the number of prints for each of sheet sizes. The state information table 153a may store a counter value indicating the number of times of operation of an apparatus other than the printer 120. For example, the state information table 153a may store a counter value obtained by counting the number of original documents read by the scanner 100.

The communication interface 154 is an interface for performing communication with an external apparatus. The communication interface 154 is an interface for communicating with the management apparatus 3 via a network. The scanner control unit 155 controls the scanner 100 according to an instruction from the CPU 150. The printer control unit 156 controls the printer 120 according to an instruction from the CPU 150. The operation panel 157 is a panel to which an operation instruction by a user is input. The operation panel 157 includes a display unit and operation keys. For example, the operation panel 157 includes a display device, which includes a touch panel, and hard keys.

The output interface 158 is an interface configured to output data (spot collection data) output according to the operation by a serviceperson. The spot collection data only has to be, for example, data equivalent to detailed data periodically transmitted by the first MFP. For example, only data equivalent to simplified data periodically transmitted by the second MFP may be able to be output as the spot collection data according to the operation by the serviceperson.

The output interface 158 only has to be an interface configured to output data that the serviceperson can carry to a service center and input to the management apparatus 3. For example, the output interface 158 only has to be an interface that can output the spot collection data to a locally-connected storage medium such as a memory card or an external storage device as long as an input interface 24 of the management apparatus 3 is an interface configured to capture data from the locally-connected storage medium such as the memory card or the external storage device. The output interface 158 may be an interface configured to perform output for printing information indicating the spot collection data on paper with the printer 120 as long as the input interface 24 of the management apparatus 3 is an interface configured to input information key-input by a keyboard or the like.

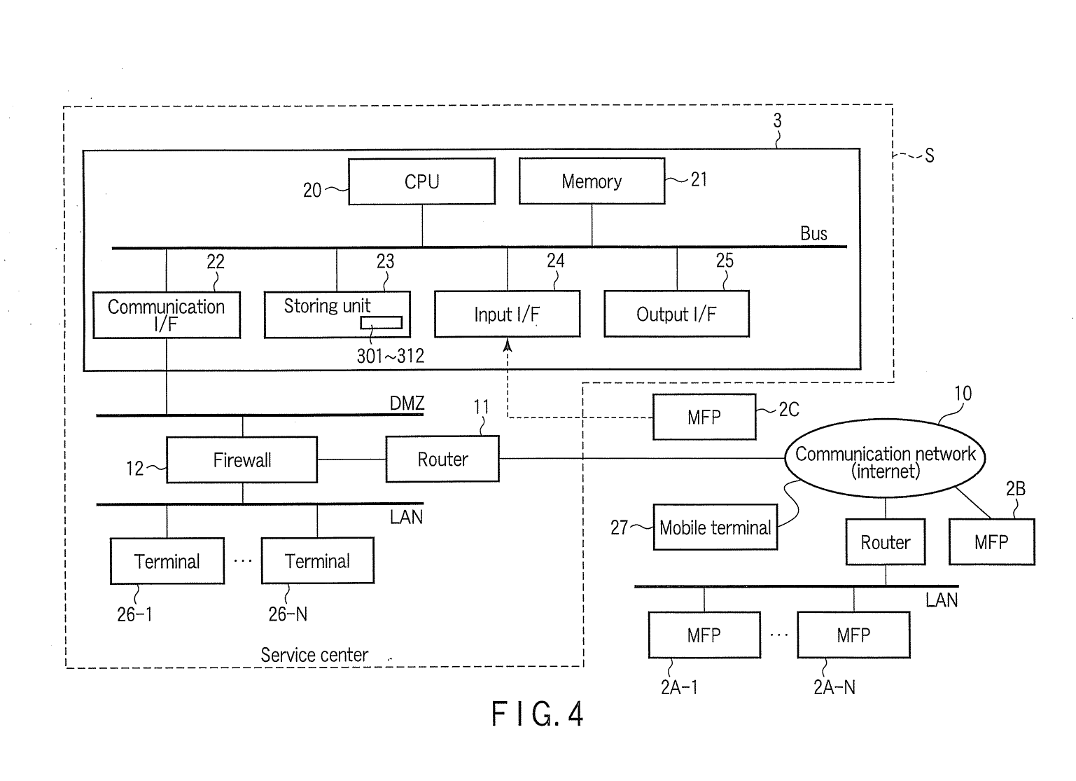

FIG. 4 is a diagram of configuration examples of the maintenance scheduling system and the management apparatus 3.

In the maintenance scheduling system (a maintenance system), a service center S, in which the management apparatus 3 is set, acts as a base and performs a maintenance service for a plurality of the MFPs 2. In the service center S, a router 11 and a firewall 12 are provided to eliminate illegal accesses from the outside. The management apparatus 3 is set in a demilitarized zone (DMZ) by the firewall 12. Only a specific access to the management apparatus 3 is permitted.

The management apparatus 3 includes a CPU (a processor) 20, a memory 21, a communication interface 22, a storing unit 23, the input interface 24, and an output interface 25.

The CPU 20 manages overall control of the entire management apparatus 3. The CPU 20 includes a function of realizing various kinds of processing by executing computer programs. The memory 21 stores the computer programs to be executed by the CPU 20. For example, the memory 21 stores computer programs for causing the CPU 20 to function as a failure-history analyzing unit 204, a maintenance scheduling unit 206, a counter converting unit 208, and a latest-value calculating unit 209 explained later. The computer programs to be executed by the CPU 20 may be stored in the storing unit 23.

The communication interface 22 is an interface for exchanging information with the MFP 2 via the communication network 10. The communication interface 22 also functions as an interface for communicating with terminals 26 via the firewall 12 and a LAN in the service center S. The storing unit 23 stores data and the like acquired from the MFPs 2 via the communication interface 22 and the input interface 24. The data acquired from the MFPs 2 is data concerning a maintenance history, data concerning a state of use, and the like.

The input interface 24 is an interface for inputting data. The input interface 24 is an interface for inputting an operation instruction and data with an input device such as a keyboard or a mouse. The input interface 24 may be an interface for inputting data from a locally-connected storage medium such as a memory card or an external storage device. The output interface 25 is an interface for outputting information. The output interface 25 may be an interface for outputting data to the locally-connected storage medium such as a memory card or an external storage device, may be an interface for outputting data for printing information on paper with a printer, or may be an interface for outputting display data to a display device.

An outline of maintenance scheduling for the MFP 2 is explained below.

As maintenance of the image processing apparatus such as the MFP 2, there are preventive maintenance (PM) and emergency maintenance (EM). In the PM, a serviceperson P visits the MFP 2 to be maintained and performs replacement of consumables, cleaning, and operation check for the MFP 2 at periodic timing set for each of the MFPs. In the EM, when a failure accidentally occurs, the serviceperson P receives a service call from the user, visits a customer, and repairs the MFP 2.

Concerning PM work, since plural consumables are present for one MFP 2, not all the consumables are deteriorated when the PM is performed. A loss occurs if consumables not exhausting lives are replaced. When a failure accidentally occurs, if only a part of broken consumables are replaced, a replacement period for the replacement consumables deviates from a cycle of the PM.

If the serviceperson P visits the customer to perform the PM Or the EM in such a situation, it is difficult to determine which components are replaced and which components continue to be used.

Although the serviceperson P works on the basis of the set PM cycle, the serviceperson P attempts to separately perform adjustment of a replacement period for the consumables on the basis of experiences and reduce losses. However, if the serviceperson P attempts to reduce cost by thoughtlessly delaying the replacement period and extending time of use of the consumables, on the contrary, a risk of failure of the consumables rises and damage to the user due to unavailability of the MEP occurs. If the replacement period is changed for each of the consumables, it is also conceivable that the number of times of visit increases and maintenance cost increase on the contrary.

Therefore, the maintenance scheduling system according to this embodiment creates a more detailed maintenance schedule for the consumables rather than replacing the consumables according to only the PM cycle. Specifically, the maintenance scheduling system sets two indexes, i.e., a “visit interval” indicating “when the serviceperson P visits a customer” and a “replacement interval” indicating “which components should be replaced” when the serviceperson P visits the customer. The serviceperson P visits the customer according to the “visit interval”. When the serviceperson P visits the customer to perform the PM or the EM, the maintenance scheduling system determines, according to the “replacement interval”, necessity of replacement for components other than components to be subjected to the PM or the EM. Accordingly, the maintenance cost and the risk of failure are optimized.

The classification of the digital multifunction peripherals (MFPs) 2 to be subjected to maintenance scheduling in the maintenance scheduling system according to this embodiment is explained below.

In the maintenance scheduling system according to this embodiment, the digital multifunction peripherals to be subjected to maintenance scheduling are classified into three digital multifunction peripherals, i.e., the first, second, and third digital multifunction peripherals 2A, 2B, and 2C.

As explained above, the first digital multifunction peripheral 2A periodically transmits detailed data to the management apparatus 3 via the communication network 10. The detailed data is data indicating, in detail, an operation state (a state of use) of the entire apparatus such as values of sensors and counters in the digital multifunction peripheral 2. For example, the detailed data includes values detected by the sensors such as an output value of a sensor configured to measure the surface potential of the photoconductive drum 102 and a sensor configured to measure the internal temperature of the fixing device 111, present life counter values of consumables (counter values corresponding to physical amounts effective for grasping deterioration degrees of the consumables), and a total counter value (a total number of sheets printed by a MFP). The detailed data may be data including all data that can be output indicating a state of use of a digital multifunction peripheral.

The detailed data only has to be stored in the state information table 153a of the nonvolatile memory 153. The first digital multifunction peripheral 2A only has to periodically extract the detailed data from the state information table 153a and transmit the extracted detailed data to the management apparatus 3.

The second digital multifunction peripheral 2B periodically transmits simplified data to the management apparatus 3 via the communication network 10. The simplified data is data as a part of the data included in the detailed data. For example, the simplified data may be data for charging a user according to the number of printed sheets. As the simplified data used for the charging, counter values such as the number of color prints, the number of monochrome prints, and the number of prints by size and a total counter value as an entire number of prints are often included. In this embodiment, at least the total counter value is included in the simplified data.

The second MFP 2B may store data equivalent to the detailed data in the state information table 153a of the nonvolatile memory 153. In this case, the second MFP 2B periodically extracts the simplified data including the total counter value from the data stored in the state information table 153a and transmits the extracted simplified data to the management apparatus 3. The second MFP 2B can output data other than the simplified data, which is stored by the state information table 153a, as stop collection data according to human operation by the serviceperson P in the same manner as output of spot collection data by the third MFP 2C explained later.

The third digital multifunction peripheral 2C inputs the detailed data or the simplified data to the management apparatus 3 via the help of a serviceperson or the like without performing communication with the management apparatus 3 via the communication network 10. The third digital multifunction peripheral 2C adopts an operation form for making it impossible (unnecessary) to perform network connection to external apparatuses (including the management apparatus 3) via the communication network 10. Therefore, a hardware configuration itself of the third digital multifunction peripheral 2C may be the same as the first or second digital multifunction peripheral as long as the third digital multifunction peripheral 2C is not connected to the network.

The third MFP 2C may store data equivalent to the detailed data explained above in the state information table 153a of the nonvolatile memory 153. In this case, the third MFP 2C outputs the data stored in the state information table 153a via the output interface 158 according to direct operation by the serviceperson P. In other words, the third MFP 2C can output, in a predetermined format, spot collection data equivalent to the detailed data or spot collection data equivalent to the simplified data according to human operation by the serviceperson P. Data extracted from the third MFP 2C according to the operation by the serviceperson P is input to the management apparatus 3 by human operation by the serviceperson P.

The three classifications correspond to operation forms of the MFPs. Even if the MFPs 2 are the same type, since an environment of use or a purpose of use is different for each of the MFPs, in the operations of the MFPs 2, data that can be acquired or a method of acquiring data is different.

For example, a digital multifunction peripheral operated as a dedicated copying machine is often operated as the third digital multifunction peripheral 2C not having a communication function with an external apparatus. In a setting environment in which there is no facility that can perform network connection to an external apparatus via a communication line, a digital multifunction peripheral is often operated as the third digital multifunction peripheral 2C. In a setting environment in which network connection to an external apparatus via a communication line is strictly restricted, a digital multifunction peripheral is also often operated as the third digital multifunction peripheral 2C.

A digital multifunction peripheral operated in an operation form not dealing with maintenance and the like from a remote location and dealing with to only a charging service from a remote location is operated as the second digital multifunction peripheral 2B. The second digital multifunction peripheral 2B dealing with only a charging service does not notify the management apparatus 3 of detailed data concerning a state of the apparatus and notifies the management apparatus 3 of only simplified data such as a total counter value related to charging. In a setting environment in which data to be transmitted is restricted because, for example, a communication environment is insufficient and a large volume of data cannot be transmitted, a digital multifunction peripheral is also operated as the second digital multifunction peripheral 2B.

As explained above, even a digital multifunction peripheral having a communication function with the management apparatus 3 often cannot transmit the detailed data to the management apparatus 3 in an actual operation form. Therefore, to deal with actual various operation forms, in some case, it cannot be said that the system as a whole is efficient if only a maintenance schedule for the first digital multifunction peripheral 2A is created. Therefore, the maintenance scheduling system according to this embodiment creates maintenance schedules for not only the first digital multifunction peripheral 2A but also the second digital multifunction peripheral 2B and the third digital multifunction peripheral 2C.

For example, for the second digital multifunction peripheral 2B, the management apparatus 3 estimates data necessary for creation (optimization) of a maintenance schedule (data equivalent to detailed data) from simplified data, which can be periodically acquired, and creates a maintenance schedule from the estimated data.

For the third digital multifunction peripheral 2C, the management apparatus 3 acquires detailed data or simplified data according to a method (human data input) other than communication via the communication network 10, estimates data necessary for creation (optimization) of a maintenance schedule (data equivalent to the detailed data) from the acquired data, and creates a maintenance schedule.

Creation of a maintenance schedule for the first digital multifunction peripheral 2A is explained below.

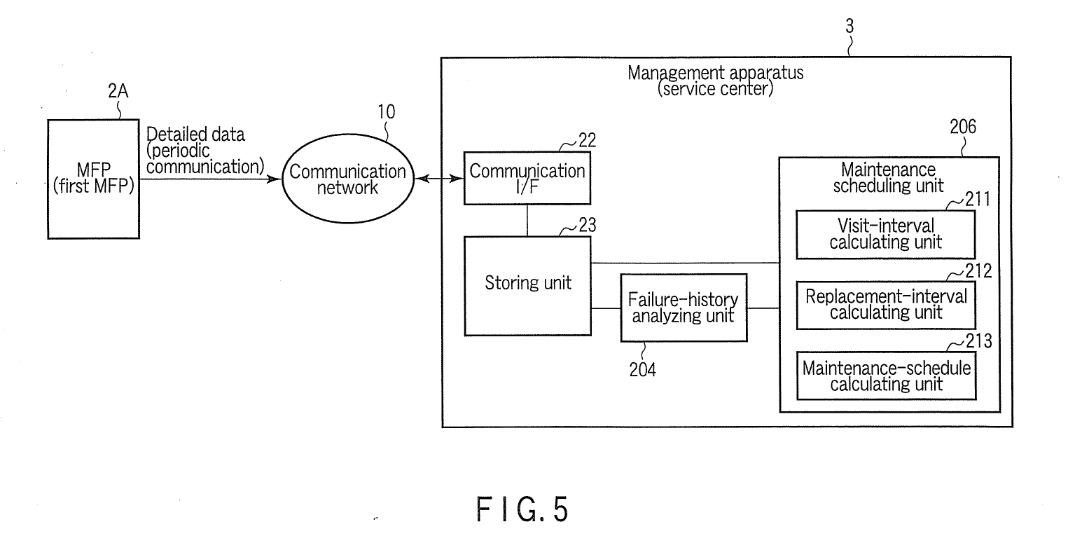

FIG. 5 is a schematic diagram for explaining processing for creating a maintenance schedule for the first digital multifunction peripheral (MFP) 2A. The processing for creating a maintenance schedule for the first MFP 2A shown in FIG. 5 is explained. The serviceperson P provides, from the service center S as a base, a maintenance service for the plural MFPs 2 set in plural places and operated in various forms.

After maintenance work by the serviceperson P ends, the MFPs 2A and 2B having a communication function transmit maintenance history data to the management apparatus 3 via the communication network 10. The management apparatus 3 receives the maintenance history data from the MFPs via the communication interface 22 and stores the received maintenance history data in the storing unit 23.

When maintenance work for the MFP 2C not having a communication function is performed, after returning to the service center S, the serviceperson P inputs maintenance history data to the management apparatus 3 from a work record summarized as a report of a maintenance job. The management apparatus 3 receives the maintenance history data, which is input by the serviceperson P, via the input interface 24 and stores the input maintenance history data in the storing unit 23. Even in the MFPs 2A and 2B having the communication function, the serviceperson P may input the maintenance history data to the management apparatus 3.

When set periodic communication time (e.g., 10 o'clock everyday) comes, the MFP 2A having the communication function collects data concerning a state of use and transmits the collected data to the management apparatus 3 as detailed data. The management apparatus 3 receives the detailed data from the MFP 2A via the communication interface 22 and stores the received detailed data in the storing unit 23. When the set periodic communication time (e.g., 10 o'clock everyday) comes, the MFP 2B having the communication function transmits predetermined simplified data to the management apparatus 3. The management apparatus 3 receives the simplified data from the MFP 2A via the communication interface 22 and stores the received simplified data in the storing unit 23. The management apparatus 3 creates a maintenance schedule for the first MFP 2A according to the maintenance history data and the detailed data stored in the storing unit 23. The management apparatus 3 includes the failure-history analyzing unit 204 and the maintenance scheduling unit 206 as functions for creating a maintenance schedule. The failure-history analyzing unit 204 and the maintenance scheduling unit 206 may be, for example, processing functions realized by the CPU 20 executing a computer program stored in the memory 21. The failure-history analyzing unit 204 calculates a failure ratio distribution for each of consumables on the basis of maintenance history data in the past stored in the storing unit 23 and performs failure estimation on the basis of the failure ratio distribution. The maintenance scheduling unit 206 calculates, according to data (detailed data) concerning states of use collected from the MFPs 2 via the communication network 10, a list of consumables to be replaced in the next visit period and visit time.

Functions of components for the management apparatus 3 for creating a maintenance schedule according to detailed data acquired from the first MFP 2A by periodic communication are explained below. The failure-history analyzing unit 204 calculates a failure ratio distribution concerning consumables on the basis of maintenance history data as history information concerning maintenance work applied to the MFP 2. As explained above, the history information (the maintenance history data) concerning the maintenance work applied to the MFP 2 is input to the management apparatus 3 by communication from the MFP 2 or operation by the serviceperson P who performs the maintenance work, whereby the history information (the maintenance history data) is stored in the storing unit 23.

As shown in FIG. 5, the maintenance scheduling unit 206 includes a visit-interval calculating unit 211, a replacement-interval calculating unit 212, and a maintenance-schedule calculating unit 213 as main processing functions.

The maintenance-scheduling unit 206 calculates, with the visit-interval calculating unit 211, a “visit interval”, which specifies a time interval at which the serviceperson P should visit a customer to perform maintenance work, for consumables on the basis of failure ratio distributions of the consumables and predetermined cost and risk. The maintenance scheduling unit 206 calculates, with the replacement-interval calculating unit 212, a “replacement interval”, which specifies a time interval at which the consumables should be replaced, for the consumables on the basis of the failure ratio distributions of the consumables and the predetermined cost and risk.

Examples of the “consumables” include the photoconductive drum 102, an electrifying charger wire, a fixing roller, and a transfer belt. The “consumables” may include a cartridge in which plural consumable components respectively having different functions are integrated as a unit.

The “predetermined cost and risk” is a total of personnel expenses required for maintenance work by a serviceperson, material expenses of consumables, and an amount of loss caused because a user cannot use a machine to be maintained.

On the other hand, the first MFP 2A periodically transmits detailed data including present life counter values of the consumables to the management apparatus 3 via the communication network 10. The life counter value means a counter value corresponding to a physical amount effective for grasping deterioration degrees of the consumables mounted on the MFP 2, for example, a cumulative number of revolutions in the case of the photoconductive drum 102 and a cumulative driving time in the case of the charging device 103. For maintenance of the components in the MFP 2, a total counter value indicating the number of processed images (e.g., the number of scanned documents or the number of processed sheets such as the number of printed sheets) in the MFP 2 is often used. However, as functions of an MFP are more complicated, it is more difficult to determine, only with the total counter value, suitable progress of deterioration for each of components. For example, in a color machine (an MFP adapted to color), since photoconductive drums 102 for colors do not operate during monochrome printing, it is difficult to appropriately determine, only with the total counter value, deterioration in the photoconductive drums. In a MFP in which sheet trays 113 are provided in multiple stages according to paper sizes, since a frequency of use is large depending on a sheet tray, it is anticipated that deviation of progress of deterioration is large for each of components. Therefore, in a maintenance schedule for the MFP, it is highly necessary to manage various consumables with life counters respectively corresponding to the consumables. In the maintenance scheduling system according to this embodiment, the management apparatus 3 stores life counter values corresponding to the consumables in the MFP in the storing unit 23.

The maintenance scheduling unit 206 calculates, with the maintenance-schedule calculating unit 213, timing when the serviceperson should visit a customer next time and a list of consumables, which should be replaced at the timing, on the basis of information concerning the visit period calculated by the visit-interval calculating unit 211, information concerning the replacement period calculated by the replacement-interval calculating unit 212, and the life counter values of the consumables acquired as the detailed data from the first MFP 2A.

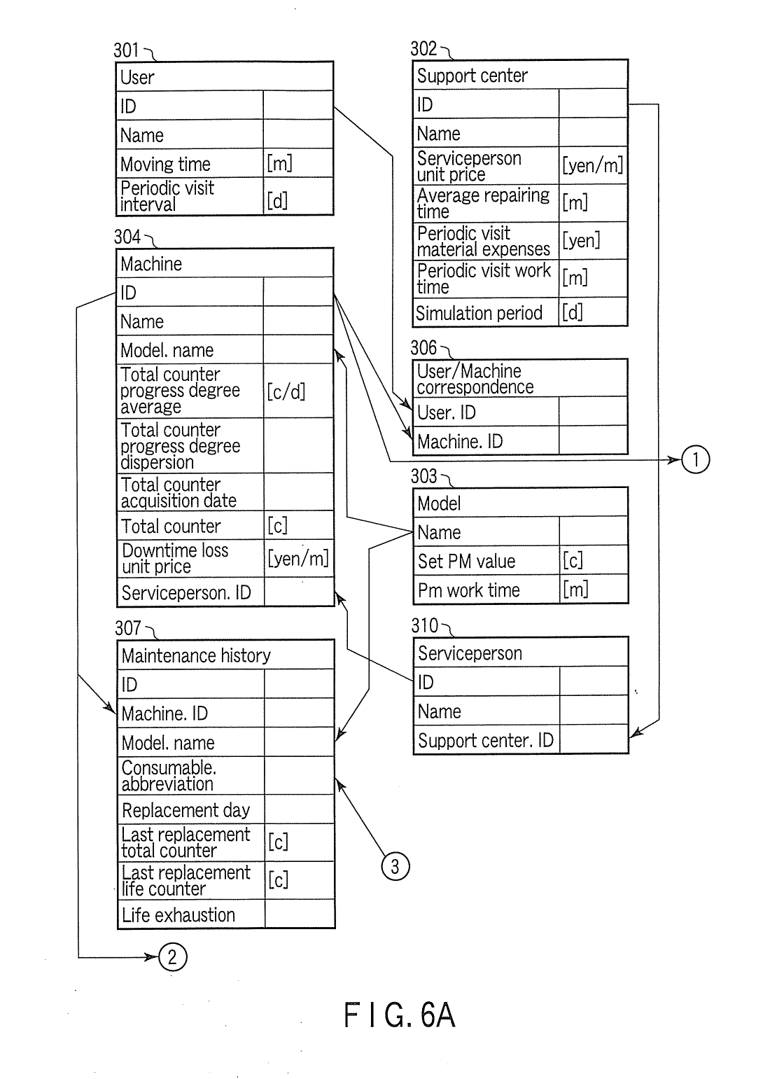

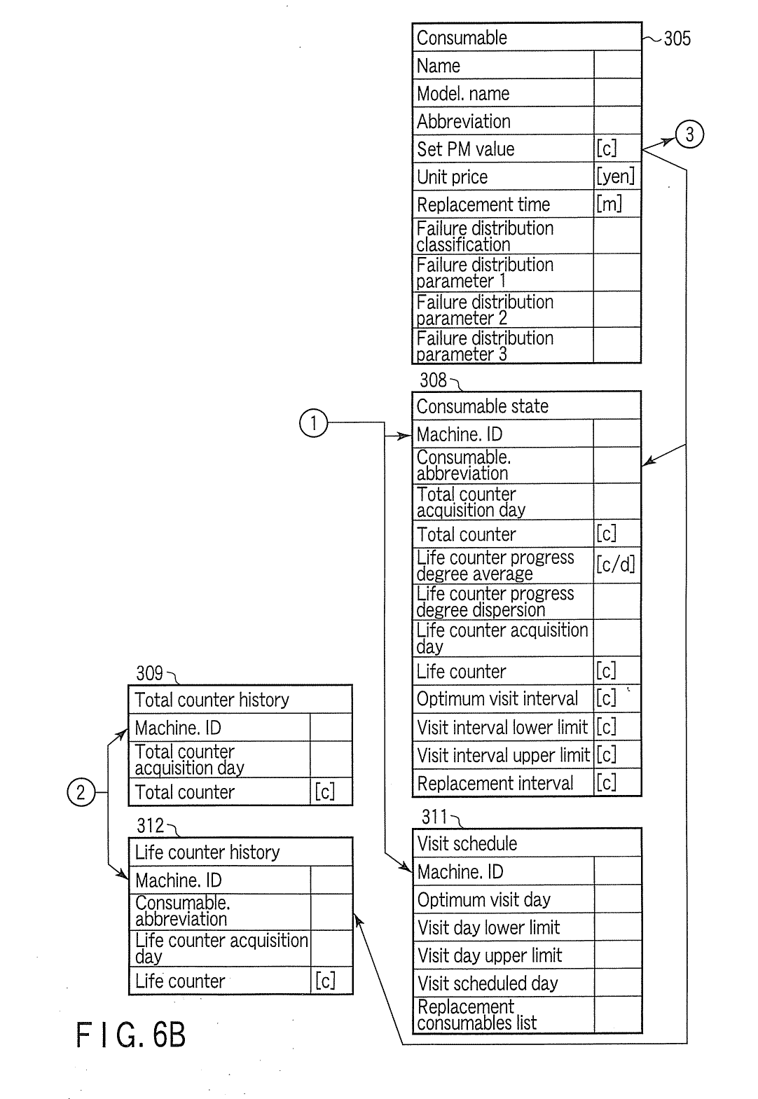

FIGS. 6A and 6B are diagrams of a relation between formats of data used in the maintenance scheduling system according to this embodiment and data tables.

The data tables used in the system include a “user” table 301, a “support center” table 302, a “model” table 303, a “machine” table 304, a “consumables” table 305, a “user and machine correspondence” table 306, a “maintenance history” table 307, a “consumables state” table 308, a “total counter history” table 309, a “serviceperson” table 310, a “visit schedule” table 311, and a “life counter history” table 312. The tables 301 to 312 are provided in the storing unit 23.

Constants for users are set in the “user” table 301. Constants for the service center S are set in the “support center” table 302. Constants for models are set in the “model” table 303. Constants for machines and variables calculated from states of use are set in the “machine” table 304. Constants for consumables and variables for failure ratios calculated from market data are set in the “consumables” table 305. Correspondence between machines owned by users and the users is shown in the “user and machine correspondence” table 306. Maintenance work histories of servicepersons are recorded in the “maintenance history” table 307. States of the consumables are set in the “consumables state” table 308. Total counter histories of the machines are recorded in the “total counter history” table 309. Constants for the servicepersons are set in the “serviceperson” table 310. Visit scheduled day and replacement consumables lists for the machines are set in the “visit schedule” table 311. A life counter history for each of the consumables of the machines is recorded in the “life counter history” table 312.

Arrows in the figures indicate that attributes at sources of the arrows are set in attributes at destinations of the arrows. A word before “.” of the attributes at the destinations of the arrows indicate a table name of a reference source and a word after “.” indicates an attribute name of the reference source. For example, “machine. ID” of the “maintenance history” table 307 represents “ID” of the “machine” table 304.

When the serviceperson P performs a maintenance job, the serviceperson P updates data set in the memory of the MFP 2.

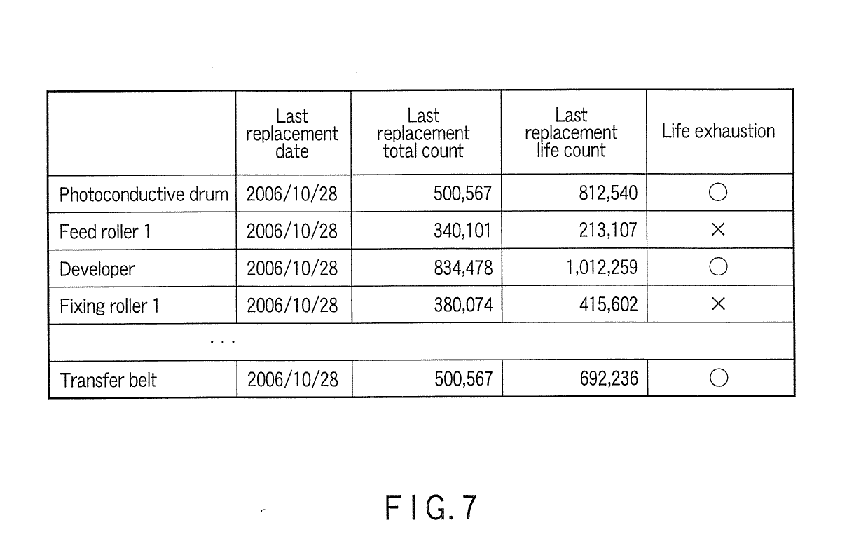

FIG. 7 is a diagram of an example of information stored in the state information table 153a of the nonvolatile memory 153 of the MFP 2. Concerning a consumable to be replaced, the serviceperson P sets a total counter value currently in use set in the memory of the MFP 2 in “last replacement total count”, sets a life counter value currently in use in “last replacement life count”, and sets the total counter value in use and the life counter value in use to 0. If the consumable is replaced because the consumable is broken, the serviceperson P sets “B” in “life exhaustion” set in the state information table 153a. If the consumable is not broken but is replaced because the consumable exhausts a set life, the serviceperson P sets “A” in the “life exhaustion”.

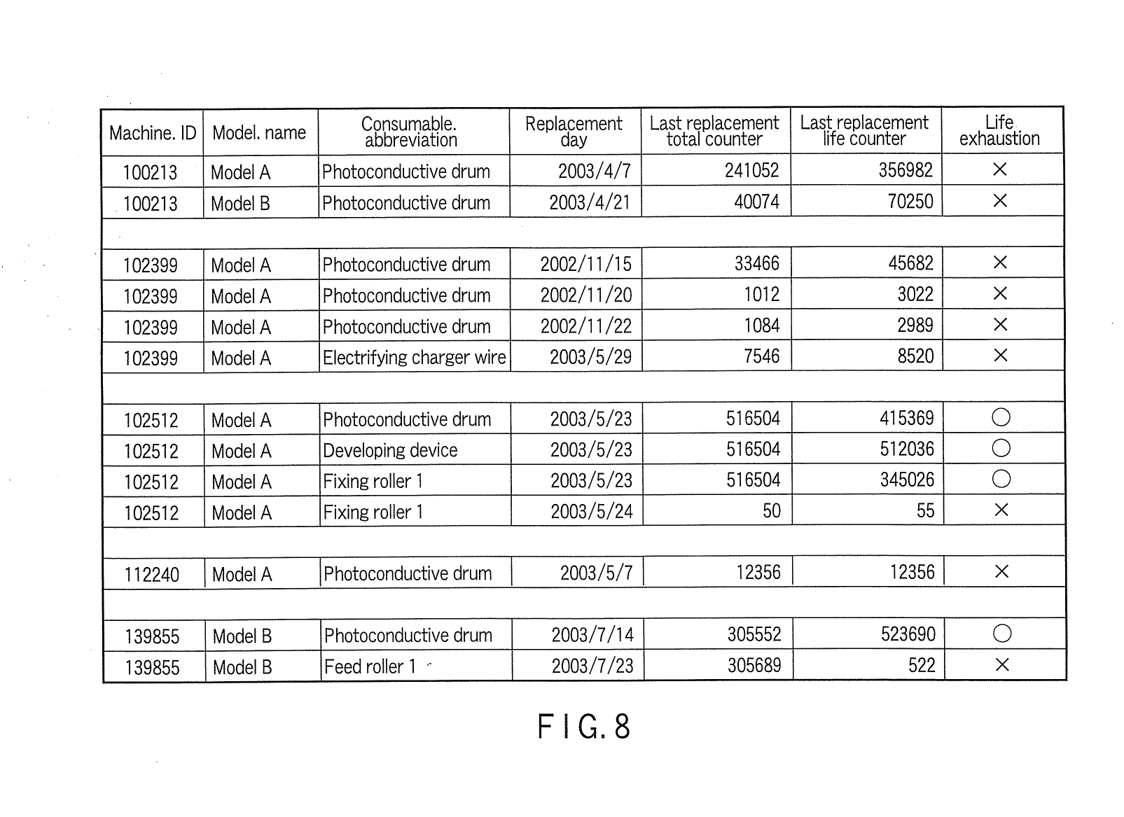

The first MFP 2A is connected to the management apparatus 3 by the communication interface 154 via the communication network 10. When maintenance work by the serviceperson P ends, the first MFP 2A transmits maintenance history data indicating contents of the maintenance work to the management apparatus 3. The management apparatus 3 that receives the maintenance history data updates the maintenance history table 307 of the storing unit 23. FIG. 8 is a diagram of an example of the maintenance history table 307, contents of which are updated as explained above.

When the periodic communication time (e.g., 10 o'clock everyday) comes, the first MFP 2A performs processing for transmitting detailed data to the management apparatus 3. For example, the CPU 150 of the first MFP 2A creates, during periodic communication, detailed data including an ID number of the MFP, a present day and time, a present total counter value, a present total counter value of the consumables, and a life counter value. The CPU 150 of the first MFP 2A transmits the created detailed data to the management apparatus 3. The management apparatus 3 reflects the detailed data received from the first MFP 2A on the total counter history table 309 and the life counter history table 312 of the storing unit 23. After transmitting the detailed data, the first MFP 2A checks a status of communication and additional information and ends the communication with the management apparatus 3.

The failure-history analyzing unit 204 performs estimation of failure ratio distributions of the consumables on the basis of the maintenance history table 307. In failure distribution analysis, the failure-history analyzing unit 204 performs fitting to a Weibull distribution (m: shape parameter, η: scale parameter) indicated by Formula (1):

F(t)=1−e{−(t/η)̂m} (1)

A failure distribution analyzing method for the photoconductive drum 102, which is a consumable of a model A, is explained below with reference to FIG. 8.

The failure-history analyzing unit 204 refers to the “last replacement life counter” and the “life exhaustion” read from the maintenance history table 307 of the storing unit 23 in order to calculate a failure ratio distribution of the photoconductive drum 102.

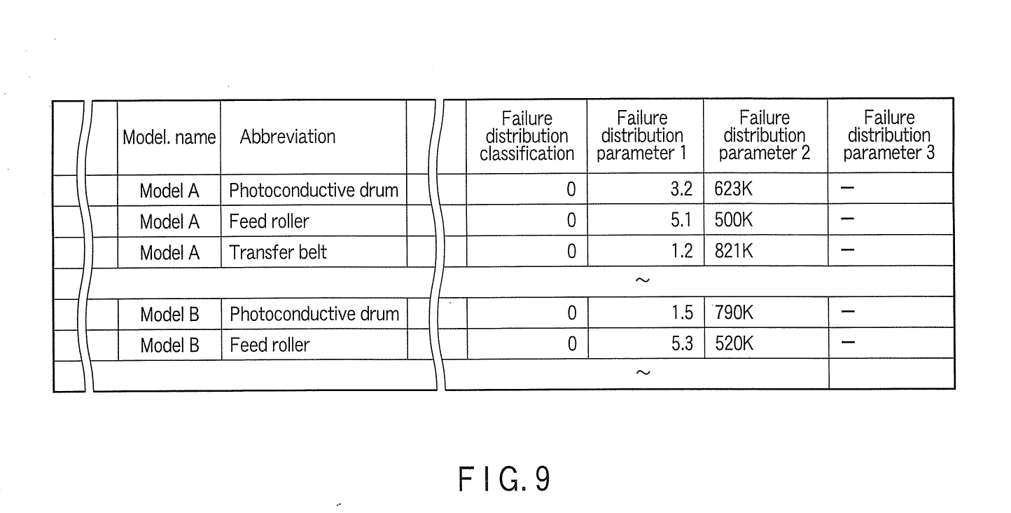

Items marked “B” in the “life exhaustion” at the right end of the maintenance history table 307 are data obtained when the photoconductive drum 102 is broken before reaching a period for the PM. Items marked “A” are data obtained when the photoconductive drum 102 is replaced because the photoconductive drum 102 reaches the period for the PM without being broken. Data including the data (the items marked “A”) replaced before being broken is referred to as “terminated data”. A cumulative hazard method is known as a method of analyzing data including the “terminated data”. The shape parameter m and the scale parameter η of the Weibull distribution are estimated on the basis of a failure interval of tuples using the cumulative hazard method. A failure distribution related variable of the consumables table 305 is updated. FIG. 9 is a diagram of an example of the consumables table 305.

The failure-history analyzing unit 204 extracts tuples, “model. name” and “abbreviation” of which in the consumables table 305 match “model A” and “photoconductive drum”, and substitutes the shape parameter m in a “failure distribution parameter 1” and substitutes the scale parameter η in a “failure distribution parameter 2”. The failure-history analyzing unit 204 sets a constant (=0) equivalent to the Weibull distribution in a “failure distribution classification”. The failure-history analyzing unit 204 performs this calculation for each of the consumables and updates the consumables table 305 of the storing unit 23. In the figure, “K” in the “failure distribution parameter 2” represents “1000” as a unit. The estimation of a failure ratio distribution is executed when a fixed amount of maintenance history data is additionally input or at periodic timing such as once a month.

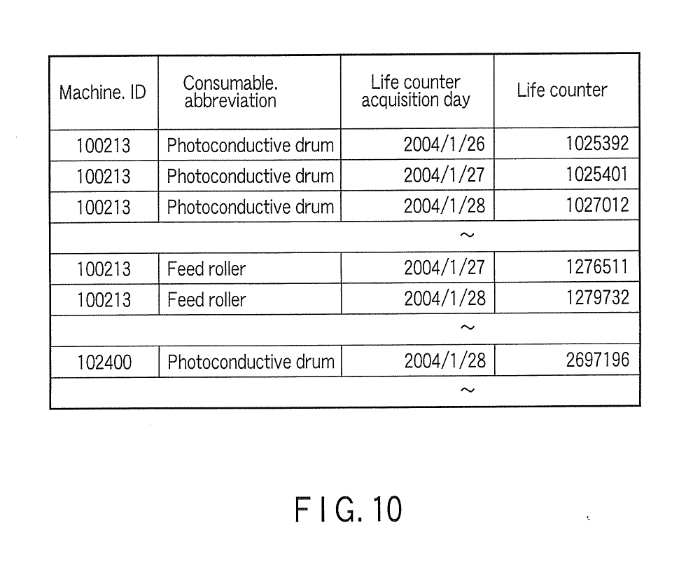

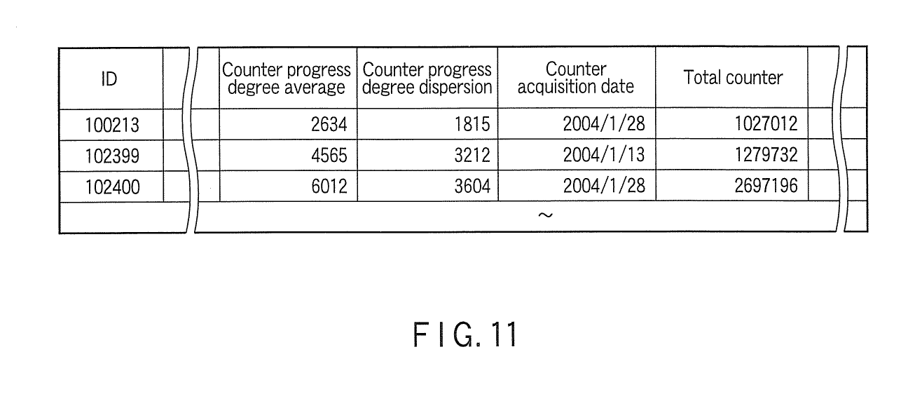

FIG. 10 is a diagram of an example of the life counter history table 312. FIG. 11 is a diagram of an example of the machine table 304.

The failure-history analyzing unit 204 calculates a progress degree distribution of a life counter per one day for each of the consumables on the basis of the life counter history table 312. Specifically, the failure-history analyzing unit 204 extracts tuples having the same “machine. ID” and “consumable. abbreviation” from the life counter history table 312. The failure-history analyzing unit 204 calculates an average and a distribution of amounts of counter change (progress degrees) per one day on the basis of a difference (in the number of days) of a “life counter acquisition day” and an amount of change of a “life counter”. The failure-history analyzing unit 204 substitutes the calculated average of the counter progress degrees in a “life counter progress degree average” in the “consumables state” table 308 and substitutes the calculated distribution of the counter progress degrees in a “life counter progress degree distribution”.

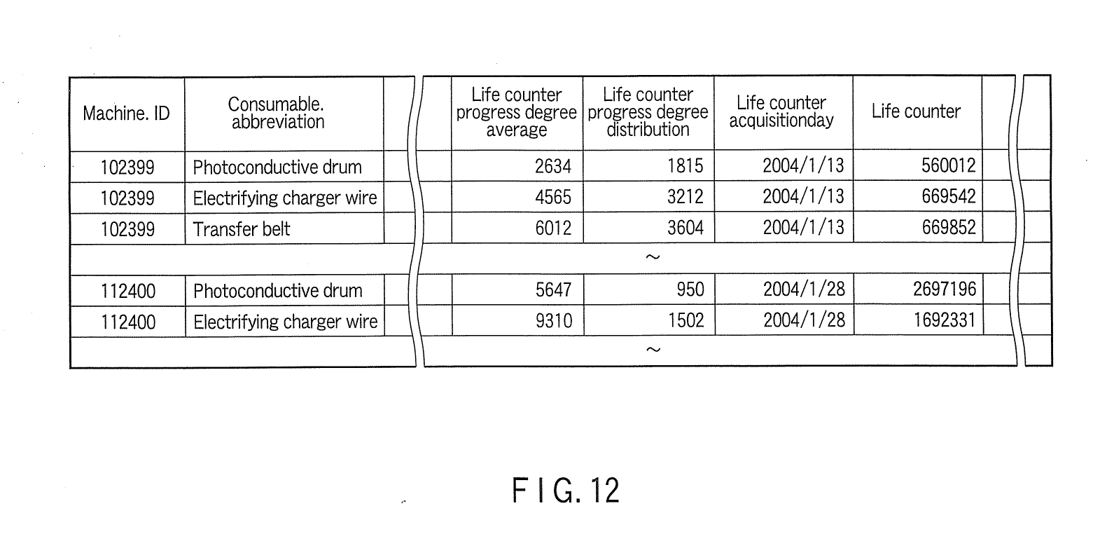

Subsequently, the failure-history analyzing unit 204 extracts tuples having the same “machine. ID” and “consumable. abbreviation” from the life counter history table 312. The failure-history analyzing unit 204 specifies tuples having a latest “life counter acquisition day” from all the extracted tuples. The failure-history analyzing unit 204 substitutes a “life counter acquisition day” of the specified tuples in a “life counter acquisition day” of the consumables state table 308 and substitutes a “life counter” value of the specified tuples in a “life counter” of the consumables state table 308. FIG. 12 is a diagram of an example of data of the consumables state table 308. The operation of the maintenance scheduling unit 206 is explained below.

The maintenance scheduling unit 206 includes a “strategy decision mode” and a “visit day presentation mode”. The “strategy decision mode” is a mode for executing, if a fixed amount of maintenance history data is additionally registered in the storing unit 23, creation of an optimum maintenance schedule at periodic timing such as once a month. The “visit day presentation mode” is a mode in which the serviceperson P checks contents of the created maintenance schedule. The serviceperson P uses this mode almost every day.

First, the “strategy decision mode” is explained.

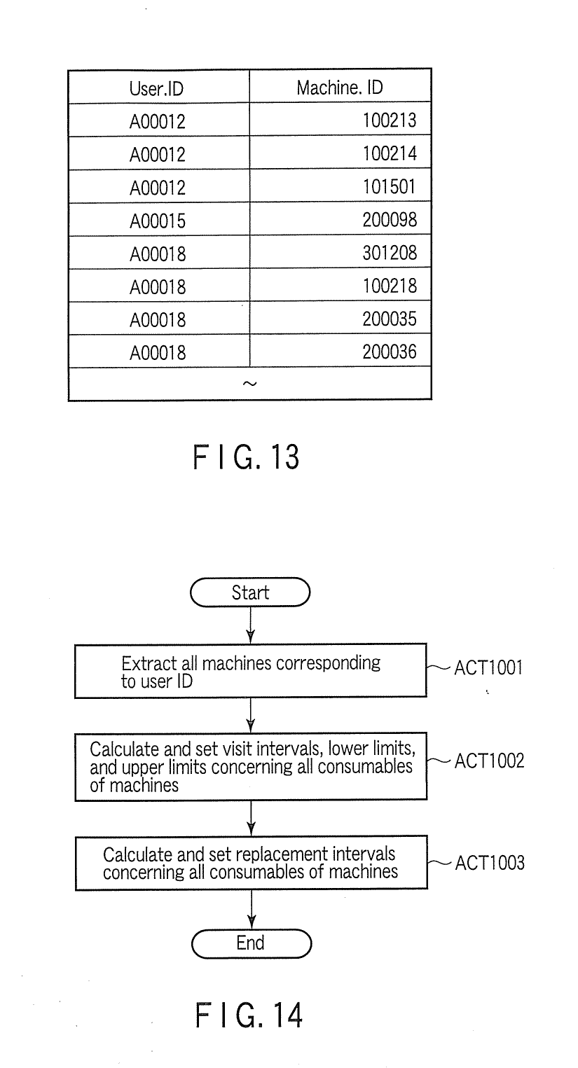

The maintenance scheduling unit 206 refers to the “user and machine correspondence” table 306 in order to extract MFPs set in the same place. FIG. 13 is a diagram of an example of the “user and machine correspondence” table 306. The maintenance scheduling unit 206 extracts all tuples collated with a “user ID” of the “user and machine correspondence” table and obtains a list of “machine IDs”. Concerning the MFPs, the maintenance scheduling unit 206 calculates, with the visit-interval calculating unit 211, a “visit interval”, a “visit interval lower limit”, and a “visit interval upper limit” for each of the consumables and calculates a “replacement interval” with the replacement-interval calculating unit 212. Further, the maintenance scheduling unit 206 calculates, with the maintenance-schedule creating unit 213, a visit scheduled day, when the serviceperson P should visit a customer, and a list of consumable of machines, which should be replaced during the visit, on the basis of the “visit interval”, the “visit interval lower limit”, the “visit interval upper limit”, and the “replacement interval”. The serviceperson P performs maintenance work on the basis of the visit scheduled day and the list of consumables.

A method of calculating the “visit interval”, the “visit interval lower limit”, the “visit interval upper limit”, and the “replacement interval” is explained below. A user having a user ID A00012 is explained in detail as an example with reference to a flowchart of FIG. 14.

In ACT 1001, the maintenance scheduling unit 206 extracts all tuples, “user IDs” of which correspond to “A00012”, from the “user and machine correspondence” table shown in FIG. 13. MFPs having the same user ID are a group of MFPs set in the same place. In the example shown in FIG. 13, “machine IDs”, user IDs corresponding to which are “A00012”, are three machine IDs “100213”, “100214”, and “101501”. Subsequently, in ACT 1002, the maintenance scheduling unit 206 calculates, with the visit-interval calculating unit 211, the “visit interval” concerning consumables of machines, “machine IDs” of which are “100213”. The visit-interval calculating unit 211 calculates, on the basis of a failure ratio distribution and predetermined cost and risk, the “visit interval”, which specified a time interval at which the serviceperson P should visit a customer to perform maintenance work, concerning the consumables.

The predetermined cost and risk is a total in a fixed period of personnel expenses required for maintenance work by a serviceperson, material expenses of replacement consumables, and an amount of loss caused because a user cannot use a machine due to an unexpected machine failure (i.e., downtime loss). The predetermined cost and risk is calculated by the following formula:

Personnel expenses=(“user. moving time”+Σ“consumable. replacement time” of replacement consumables”)×“support center. serviceperson unit price”

Material expenses=Σ “consumable. unit price” of replacement consumables

Downtime loss=“user. moving time”×“machine. downtime loss unit price”

“user. moving time” indicates a moving time from the service center S to a user location.

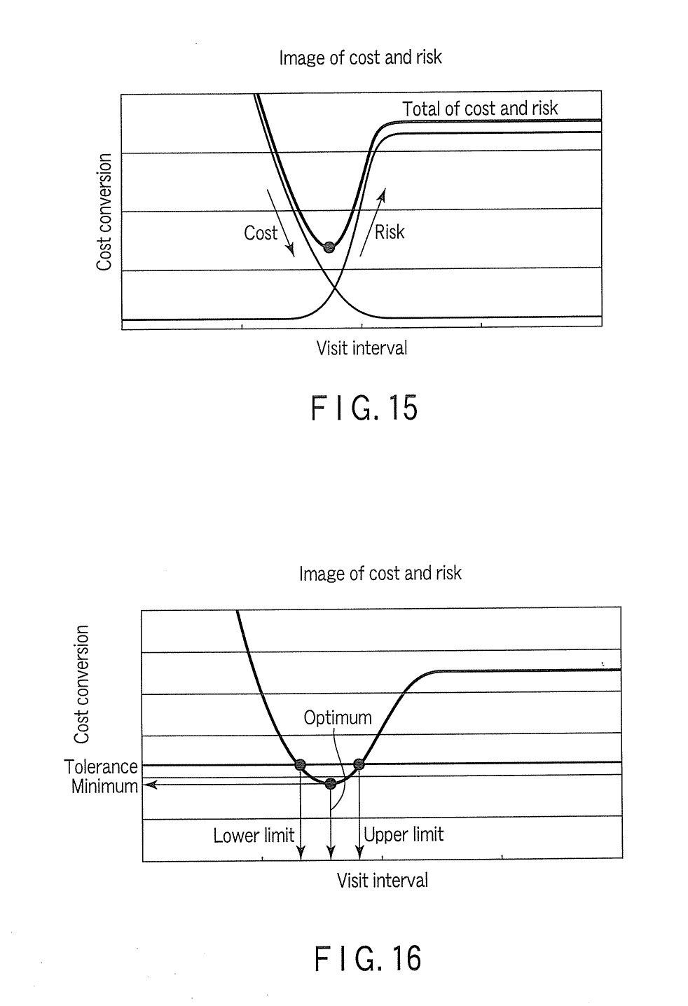

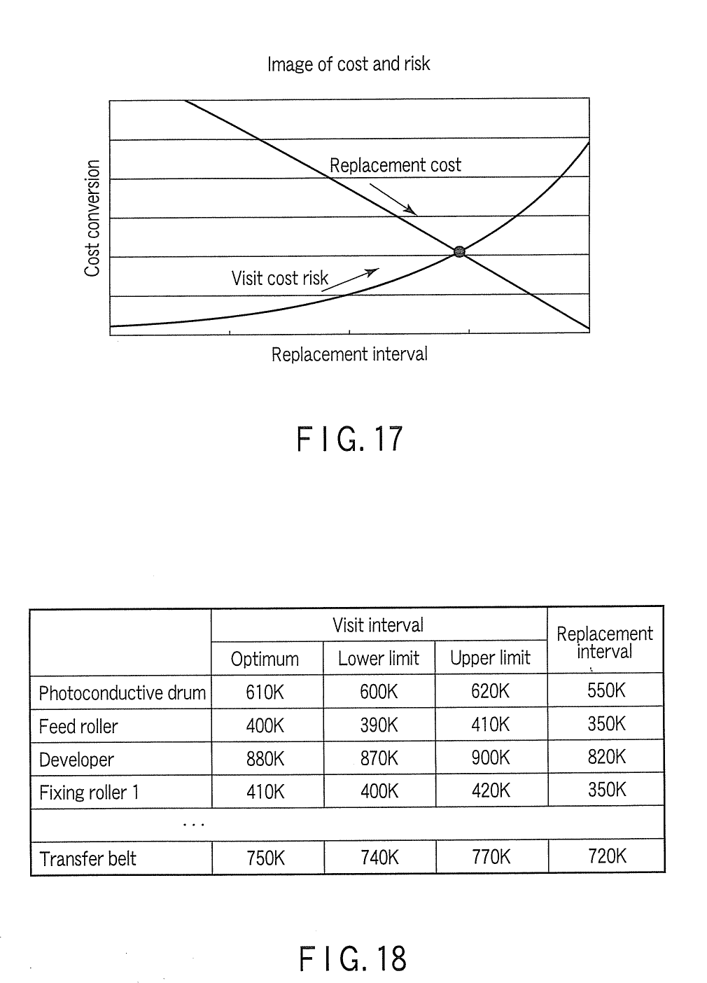

As shown in FIG. 15, if the “visit interval” is set large, since the number of times of visit decreases, cost (the personnel expenses and the material expenses) decrease. However, on the other hand, since a failure ratio increases, risk (the downtime loss) increases. Therefore, there is the “visit interval” at which the total of the cost and the risk is minimized. Further, as shown in FIG. 16, a value obtained by multiplying a minimum of a cost risk curve with a ratio set in advance (e.g., 1.05) is set as a tolerance, intersections of the tolerance and the cost risk curve are calculated, and the intersections are set as the “visit interval lower limit” and the “visit interval upper limit”.

For the calculation explained above, the maintenance calculating unit 206 retrieves an ID of a target machine from the “machine ID” of the machine table 304 and extracts the “model. name” of the machine table 304. The maintenance scheduling unit 206 extracts all consumables tables 305 including the extracted “model. name”. Similarly, the maintenance scheduling unit 206 extracts the “user ID” from the user and machine correspondence table. Subsequently, the maintenance scheduling unit 206 extracts, for each of the consumables, a failure probability represented by the “unit price”, the “replacement time”, the “failure distribution classification”, the “failure distribution parameter 1”, and the “failure distribution parameter 2” of the consumables table 305 and the “life counter progress degree average” and the “life counter progress degree distribution” of the consumables state table 308.

The maintenance scheduling unit 206 extracts a “moving time” from the user table 301 and extracts a “serviceperson unit price” from the support center table 302. The maintenance scheduling unit 206 calculates, from extracted parameters, the cost risk curve (the total of the cost and the risk) shown in FIG. 15 and calculates the “visit interval”, the “visit interval lower limit”, and the “visit interval upper limit” concerning the consumables. The maintenance scheduling unit 206 sets the calculated “visit interval”, “visit interval lower limit”, and “visit interval upper limit” concerning the consumables in the consumables state table 308. Similarly, concerning consumables of two machines, the “machine IDs” of which are “100214” and “101501”, the maintenance scheduling unit 206 also calculates the “visit interval”, the “visit interval lower limit”, and the “visit interval upper limit” and sets the “visit interval”, the “visit interval lower limit”, and the “visit interval upper limit” concerning the consumables in the consumables state table 308.

In ACT 1003, the maintenance scheduling unit 206 calculates, with the replacement-interval calculating unit 212, the “replacement interval” concerning consumables of a machine, the “machine ID” of which is “100213”. The “replacement interval” is an index for determining, when the serviceperson P visits a customer for the convenience (the PM conforming to the “visit interval” and the EM due to an unexpected failure) of the other consumables of the machine, the “machine ID” of which is “100213” and all the consumables, the “machine IDs” of which are “100214 and “101501”, whether the predetermined cost and risk is smaller if all the consumables are replaced on the opportunity of replacing the other consumables. In other words, it is possible to reduce the number of times of visit due to the PM or the EM of the consumables by replacing the target consumables on the opportunity of replacing the other consumables. However, on the other hand, since the target consumables are replaced before the consumables exhaust lives, the number of times of replacement increases.

Therefore, as shown in FIG. 16, a break-even point of cost during replacement (replacement cost) on the opportunity of the visit for the convenience of the other consumables and cost and risk (visit cost and risk) when the target consumables themselves reaches a period of the PM or the EM occurs is the “replacement interval”. The predetermined cost and risk is lower if consumables the reach the “replacement interval” during the visit are replaced.

In this way, during the visit for the convenience of the other consumables, the “machine ID” of which is “100213”, and all the consumables, the “machine IDs” of which are “100214” and “101501”, the maintenance scheduling unit 206 calculates cost during replacement (a replacement cost curve) and cost and risk (a visit cost risk curve), which is caused when the target consumables themselves reaches the period of the PM or the EM occurs, and calculates the “replacement interval”. The maintenance scheduling unit 206 sets the “replacement interval” concerning the consumables in the consumables state table 308.

Similarly, concerning the consumables of the machine, the “machine ID” of which is “100214”, the maintenance scheduling unit 206 calculates the “replacement interval” from cost during replacement (a replacement cost curve) and a visit cost risk curve of the target consumables themselves on the opportunity of the visit for the convenience of the other consumables, the “machine IDs” of which are “100214” and all the consumables, the “machine IDs” of which are “100213” and “101501”. Concerning the consumables of the machine the “machine ID” of which is “101501”, the maintenance scheduling unit 206 calculates the “replacement interval” from cost during replacement (a replacement cost curve) and a visit cost risk curve of the target consumables themselves on the opportunity of the visit for the convenience of the other consumables, the “machine IDs” of which are “101501” and all the consumables, the “machine IDs” of which are “100213” and “101501”. The maintenance scheduling unit 206 sets the “replacement interval” concerning the consumables in the consumables state table 308.

The first MFP 2A downloads, during the periodic communication, the “visit interval (optimum visit interval)”, the “visit interval lower limit”, the “visit interval upper limit”, and the “replacement interval” of the consumables state table 308 from the management apparatus as additional information and sets the same in the nonvolatile memory 153 of the first MFP 2A. Consequently, the first MFP 2A can display the “visit interval”, the “visit interval lower limit”, the “visit interval upper limit”, and the “replacement interval”, which indicate an optimum strategy, on the display unit of the operation panel 157 of the first MFP 2A as appropriate and present the same to the user. FIG. 18 is a diagram of an example of information stored in the nonvolatile memory 153 of the MFP 2. In the example shown in FIG. 18, the “optimum visit interval”, the “visit interval lower limit”, the “visit interval upper limit”, and the “replacement interval” are stored for each of consumables.

The “visit day presentation mode” is explained below.

In the “visit day presentation mode”, it is assumed that the serviceperson P routinely checks the next visit day, i.e., visit timing for a machine. The maintenance scheduling unit 206 includes a scheduling function that is periodically executed (e.g., 6 o'clock everyday). The maintenance scheduling unit 206 periodically calculates a “visit scheduled day” and a “replacement consumables list” concerning all machines registered in the machine table 304 and updates the visit schedule table 311.

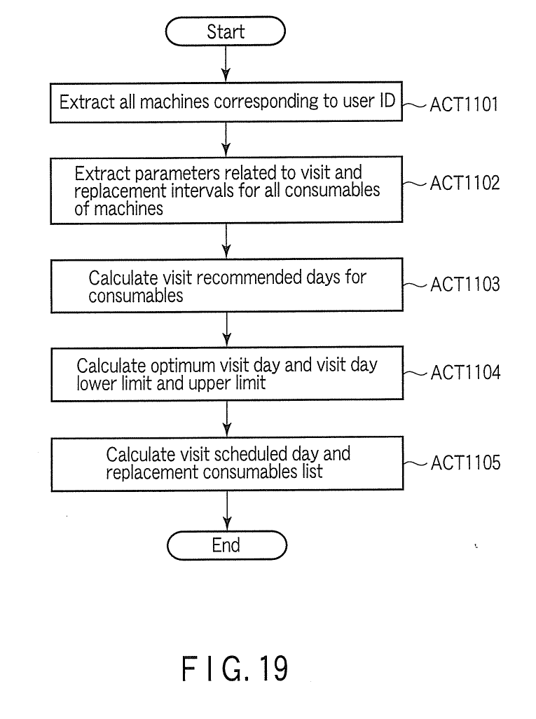

FIG. 19 is a flowchart for explaining a schematic processing procedure of the visit day presentation mode.

In ACT 1101, the maintenance scheduling unit 206 collates the “user. ID” of the user and machine correspondence table 306 with all the users registered in the “user” table 301, extracts all tuples having the “user IDs” matching the “user. ID”, and obtains the “machine ID” for each “user. ID”. Further, in ACT 1102, the maintenance scheduling unit 206 collates the extracted all “machine IDs” and the “machine ID” of the consumables state table 308. The maintenance scheduling unit 206 extracts all the consumables state tables 308 having the matching “machine IDs” and refers to the “life counter acquisition day”, the “life counter progress degree average”, the “visit interval”, the “visit interval lower limit”, the “visit interval upper limit”, and the “replacement interval”.

In ACT 1103, the maintenance scheduling unit 206 calculates, with the visit-day calculating unit 216, next visit recommended days concerning all consumables of machines to be maintained set in the same place. The maintenance scheduling unit 206 calculates the next visit recommended days according to the following Formula (4):

Visit recommended day=life counter acquisition day+(visit interval−life counter)/life counter progress degree average (4)

In ACT 1104, the maintenance scheduling unit 206 decides a shortest visit recommended day among the visit recommended days for the consumables as an optimum visit day and calculates a visit day lower limit and a visit data upper limit from consumables corresponding to the optimum visit day. The maintenance scheduling unit 206 calculates the visit day lower limit and the visit day upper limit according to Formulas (6) and (7):

Visit day lower limit=life counter acquisition day+(visit interval lower limit−life counter)/life counter progress degree average (6)

Visit day upper limit=life counter acquisition day+(visit interval upper limit−life counter)/life counter progress degree average (7)

The maintenance scheduling unit 206 sets the calculated “optimum visit day”, “visit day lower limit”, and “visit day upper limit” in the visit schedule table 311.

In ACT 1105, the maintenance scheduling unit 206 calculates, concerning all servicepersons belonging to each of support centers, visit scheduled days and replacement consumables list for machines to be managed. As a method of calculating a visit scheduled day, a linear programming method is known. The liner programming method is a method of minimizing or maximizing a target function represented by a linear expression under a constraint represented by a linear expression. As a specific algorithm, a simplex method and the like are known. With the liner programming method, it is possible to automatically solve a problem using a tool open to the public as long as only a constraint and a target function can be described. Therefore, setting of the constraint and the target function is explained in detail.

A period in which a maintenance schedule is worked out is set to n days from tomorrow. A variable indicating the number of days from today is represented as i (1≦i≦n) and the number of user base for which maintenance schedules are worked out is represented as m. A variable indicating a moving source is represented as j and a variable indicating a moving destination is represented as k. A variable indicating that a serviceperson moves from the user base j to the user base k and performs maintenance work i days from today is represented as x(i,j,k). (x(i,j,k)ε{0,1}, “1” indicates that the serviceperson moves and performs the maintenance work, and “0” indicates that the serviceperson does not move). The support centers are treated the same as the user bases and a base number is 0 (0≦j≦m, 0≦k≦m).

As the constraint, the following conditions are conceivable:

Condition 1: the serviceperson visits each user once between a visit day lower limit a(k) and a visit day upper limit b(k);
Condition 2: a total of time during which the serviceperson performs the maintenance work in a day is within a maintenance time upper limit c;
Condition 3: in a day when the serviceperson performs maintenance, the serviceperson starts movement from a support center and returns to the support center; and
Condition 4: in holidays, the serviceperson visits nowhere.

The condition 1 is represented by Formula (8):

x(a(k),0,k)+x(a(k),1,k)+ . . . +x(a(k),m,k)+x(a(k)+1,0,k)+x(a(k)+1,1,k)+ . . . +x(a(k)+1,m,k)+ . . . +x(b(k),0,k)+x(b(k),1,k)+ . . . +x(b(k),m,k)=1 (8)

The condition 2 is represented by Formula (9):

d(i,0,0)·x(i,0,0)+d(i,1,0)·x(i,1,0)+ . . . +d(i,m,0)·x(i,m,0)+d(i,0,1)·x(i,0,1)+d(i,1,1)·x(i,1,1)+ . . . +d(i,m,1)×(i,m,1)+ . . . d(i,0,m)·x(i,0,m)+d(i,1,m)·x(i,1,m)+ . . . +d(i,m,m)·x(i,m,m)≦c (9)

d(i,j,k) represents a total of a moving time from the user base j to the user base k and a working time in the base k on the i days.

The condition 3 is represented by Formulas (10) to (14):

x(i,j,0)+x(i,j,1)+ . . . +x(i,j,m)≦1 (10)

x(i,0,k)+x(i,1,k)+ . . . +x(i,m,k)≦1 (11)

x(i,0,0)+x(i,1,1)+ . . . +x(i,m,m)=0 (12)

x(i,j,0)+x(i,j,1)+ . . . +x(i,j,m)−x(i,0,j)−x(i,1,j)− . . . −x(i,m,j)=0 (13)

−m·(x(i,0,0)+x(i,0,1)+ . . . +x(i,0,m))+x(i,1,1)+x(i,1,2)+ . . . +x(i,1,m)+x(i,2,1)+x(i,2,2)+ . . . +x(i,2,m)+ . . . +x(i,m,1)+x(i,m,2)+ . . . +x(i,m,m)≦0 (14)

The condition 4 is represented by Formula 15:

assuming that a holiday is one day,

x(1,0,0)+x(1,0,1)+ . . . +(1,0,m)+x(1,1,0)+x(1,1,1)+ . . . +x(1,1,m)+ . . . +x(1,m,0)+x(1,m,1)+ . . . +x(1,m,m)=0 (15)

A target function F is represented by Formula (16) and is minimized:

F=e(1,0,0)·x(1,0,0)+e(1,0,1)·x(1,0,1)+ . . . +e(1,0,m)·x(1,0,m)+e(1,1,0)·x(1,1,0)+e(1,1,1)·x(1,1,1)+ . . . +e(1,1,m)·x(1,1,m)+ . . . +e(1,m,0)·x(1,m,0)+e(1,m,1)·x(1,m,1)+ . . . +e(1,m,m)·x(1,m,m)+ . . . +e(n,m,0)·x(n,m,0)+e(n,m,1)·x(n,m,1)+ . . . +e(n,m,m)×(n,m,m) (16)

e(i,j,k) represents a total of cost of movement from the user base j to the user base k, work cost in the base k in the i days, and component prices.

In order to calculate constants necessary for the formulas, the maintenance scheduling unit 206 refers to the tables. First, the maintenance scheduling unit 206 collates a “serviceperson ID” of the target serviceperson P with the serviceperson table 310, obtains a “support center ID”, collates the “support center ID” with the support center table 302, obtains a “simulation period”, and sets the “simulation period” in a maintenance schedule calculating period n.

Subsequently, the maintenance scheduling unit 206 collates the “serviceperson ID” of the target serviceperson P with the machine table 304 and extracts “machine IDs” of all matching tuples. The maintenance scheduling unit 206 collates the extracted all “machine IDs” with the user and machine correspondence table 306 and obtains “user IDs”. The maintenance scheduling unit 206 refers to the visit schedule table 311 for each group of “machine IDs” for which the “user ID” is the same, extracts the “visit day lower limit” and the “visit day upper limit”, subtracts a present day from a minimum visit day lower limit among visit day lower limits to obtain a(k), and subtracts the present day from a visit day upper limit corresponding to the minimum visit day lower limit to obtain b(k).

The maintenance scheduling unit 206 collates the “serviceperson ID” with the serviceperson table 310 and obtains the “maintenance time upper limit” as c. The maintenance scheduling unit 206 collates a combination of the “user IDs” with an inter-user moving time table 313 and extracts a “moving time” between bases. The maintenance scheduling unit 206 collates the “user IDs” with the user table 301 and obtains “moving times” between the support center and the users. Further, concerning dates until n days in future, in order to decide consumables to be replaced, the maintenance scheduling unit 206 extracts the “replacement interval”, the “life counter acquisition day”, the “life counter”, and the “life counter progress degree” of all the consumables having a target “machine ID” from the consumables state table 308 and calculates replacement scheduled days according to Formula (5). The maintenance scheduling unit 206 sets a consumable, the replacement scheduled day of which is before a day after i days, as a replacement target consumable on the i days, obtains a “replacement time” of the consumable from the consumables table 305, and calculates d(i,j,k) from the “moving time” and the “replacement time”.

Replacement scheduled day=life counter acquisition day+(replacement interval−life counter)/life counter progress degree average (5)

For the calculation of e(i,j,k), in the same manner as explained above, the maintenance scheduling unit 206 extracts the “moving time” between bases and a replacement target consumable in the i days and then obtains a “replacement time” and a “unit price” of the replacement target consumable from the consumables table 305. Further, the maintenance scheduling unit 206 traces the serviceperson table 310 and the support center table 302 from the “serviceperson ID” and extracts the “serviceperson unit price”. The maintenance scheduling unit 206 adds the “unit price” of the replacement target consumable to a value obtained by multiplying the “moving time” and the “replacement time” of the replacement target consumable with the “serviceperson unit price” and calculates e(i,j,k).

The maintenance scheduling unit 206 calculates, using the linear programming method, visit scheduled days for the machines from the constraint and the target function formulated as explained above. The maintenance scheduling unit 206 compares the visit scheduled days and the replacement scheduled days to determine a replacement consumables list on the visit scheduled days and sets the replacement consumables list in the visit schedule table 311.

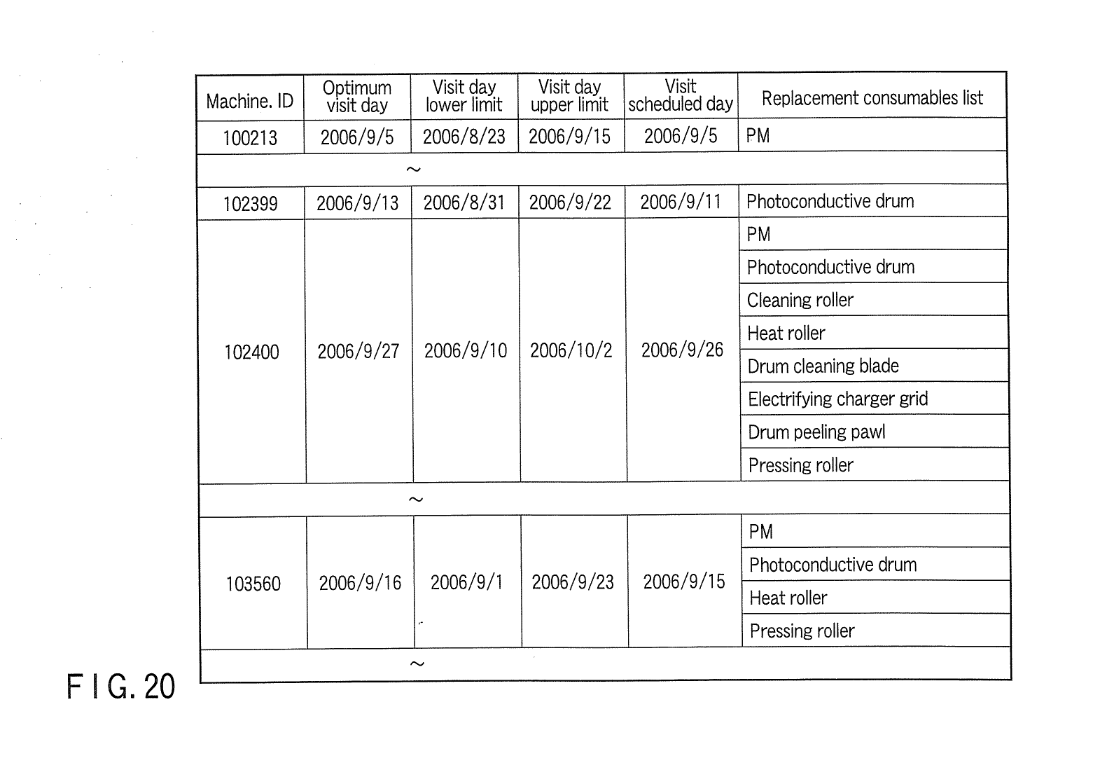

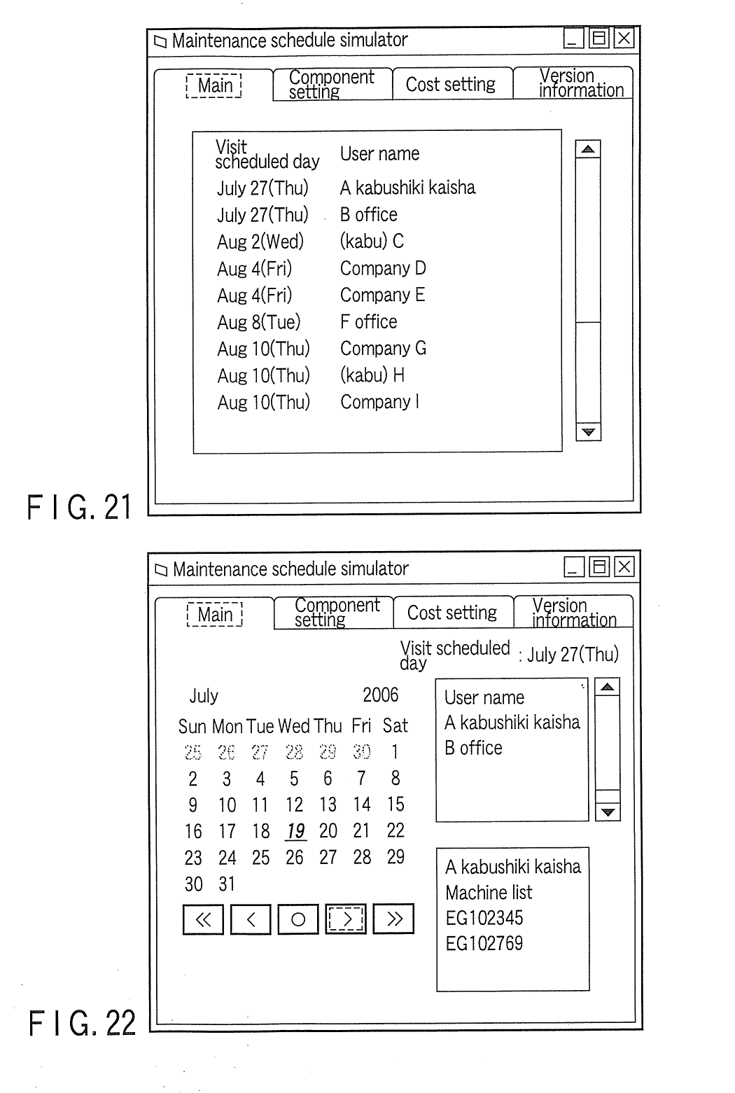

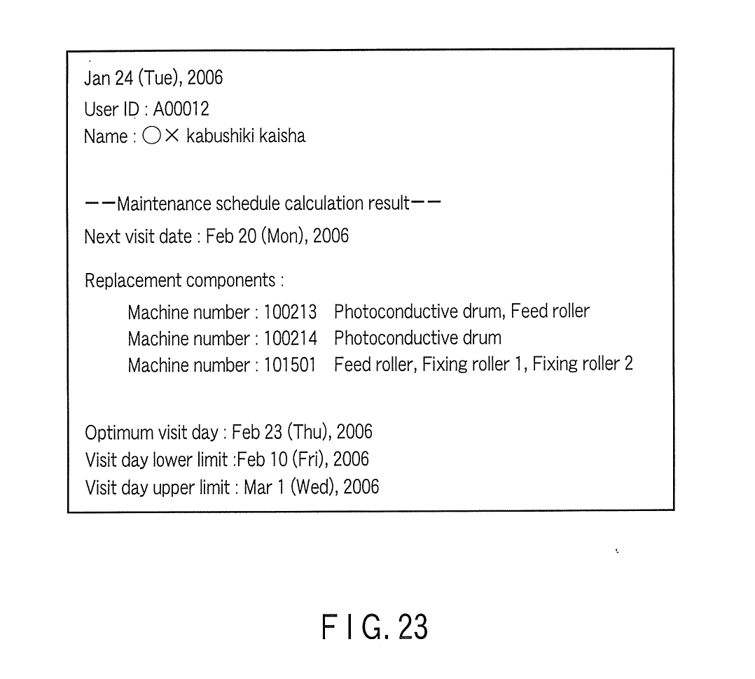

FIG. 20 is a diagram of an example of the visit schedule table 311 after the execution of the “visit day presentation mode”. FIGS. 21 and 22 are diagrams of display examples of visit scheduled days calculated by processing in the “visit day presentation mode”. FIG. 21 is a display example in which the calculated visit scheduled days are displayed as a list. FIG. 22 is a display example in which the visit scheduled days are displayed on a calendar. The serviceperson P can grasp a schedule in future by, for example, looking at a display screen shown in FIG. 21 or 22 in a terminal of the service center S. FIG. 23 is a diagram of an example in which detailed contents of maintenance work for users are printed on paper. The contents shown in FIG. 23 may be displayed on the terminal of the service center S. According to the example shown in FIG. 23, the serviceperson P can check detailed contents of the maintenance work for the users.

Processing for creating a maintenance schedule for the second digital multifunction peripheral 2B is explained below.

As explained above, concerning the first MFP 2A, the management apparatus 3 creates a maintenance schedule according to a life counter value included in detailed data periodically transmitted from the first MFP 2A. The second MFP 2B does not include a life counter value in simplified data to be periodically transmitted to the management apparatus 3. In order to create a maintenance schedule according to a calculation method same as the calculation method of the first MFP 2A explained above, the second MFP 2B predicts a life counter value from the simplified data and creates a maintenance schedule using the predicted life counter value.

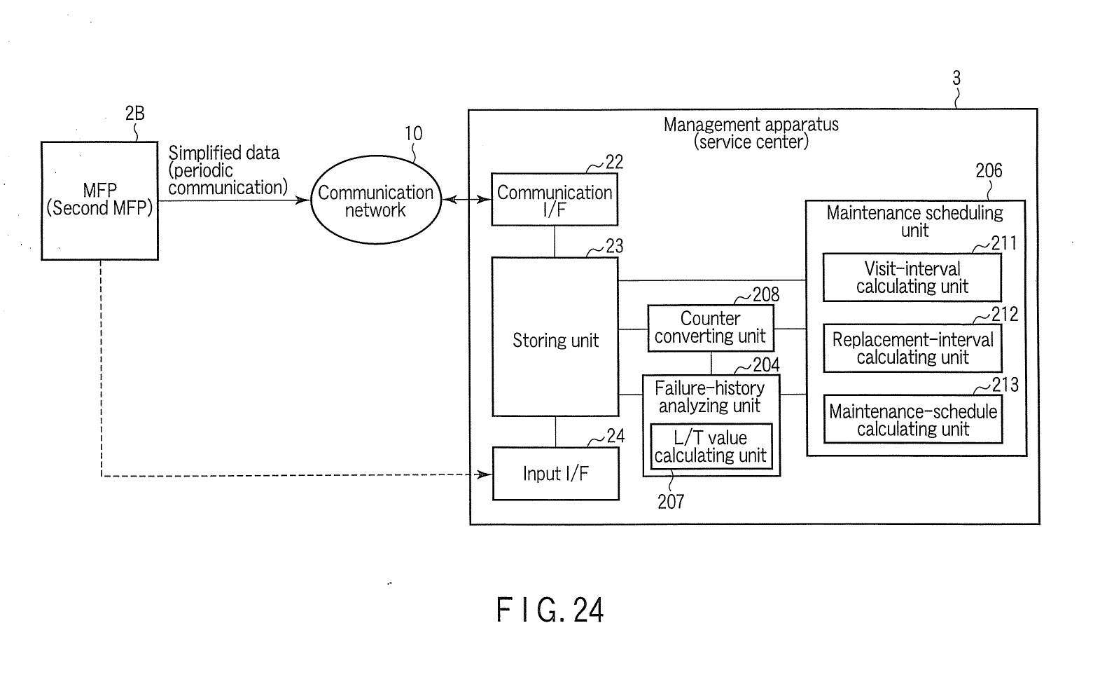

FIG. 24 is a schematic diagram for explaining the processing for creating a maintenance schedule for the second digital multifunction peripheral (MFP) 2B.

The second MFP 2B calculates data for creating a maintenance schedule from the simplified data. In the system shown in FIG. 24, the management apparatus 3 receives, via the communication interface 22, simplified data including a total counter value periodically supplied from the second MFP 2B. The management apparatus 3 stores the simplified data received via the communication interface 22 in the storing unit 23. On the other hand, spot collection data collected from the second MFP 2B according to the operation by the serviceperson P is input to the input interface 24 of the management apparatus 3. The spot collection data includes, for example, data equivalent to detailed data. The spot collection data input via the input interface 24 is stored in the storing unit 23.

The failure-history analyzing unit 204 analyzes a relation between the total counter value and life counter values of consumables according to the spot collection data stored in the storing unit 23. The failure-history analyzing unit 204 includes an LT-value calculating unit 204a configured to calculate an LT value as a relation value indicating a relation between the total counter value and the life counter values of the consumables. The failure-history analyzing unit 204 sets, in the counter converting unit 208, the LT value indicating the relation between the total counter value and the life counter values of the consumables. The counter converting unit 208 converts the total counter value into a life counter value according to the LT value set by the failure-history analyzing unit 204.

The counter converting unit 208 reads out a latest total counter value (latest simplified data acquired from the second MFP 2B) from the storing unit 23 and converts the read-out latest total counter value into life counter values of the consumables (data for creating a maintenance schedule for the second MFP 2B) according to the LT value. In other words, the counter converting unit 208 converts, using the relation value set by the failure-history analyzing unit 204, the simplified data into the data for creating a maintenance schedule. The counter converting unit 208 outputs the calculated data for creating a maintenance schedule (e.g., the latest life counter value) to the maintenance scheduling unit 206. The maintenance scheduling unit 206 creates, using the data calculated by the counter converting unit 208, a maintenance schedule for the second MFP 25 in the same manner as the creation of the maintenance schedule for the first MFP 2A.

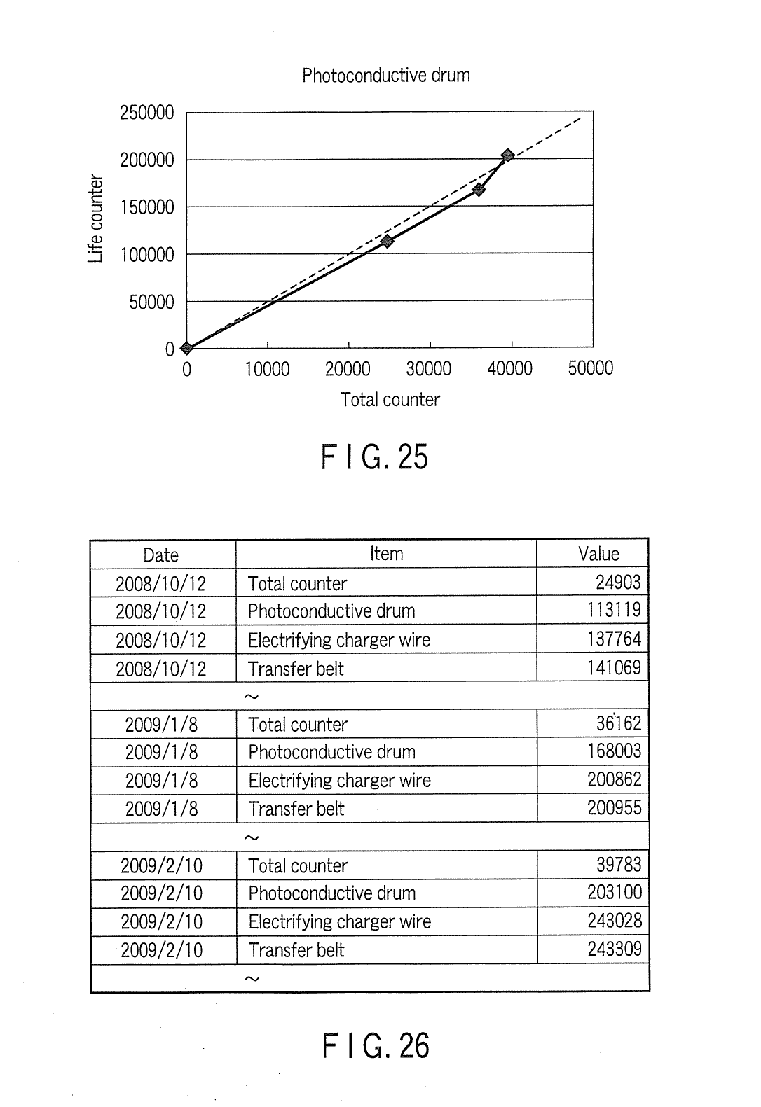

FIG. 25 is a diagram of an example of a relation between a life counter value and a total counter value concerning a certain consumable. According to the example shown in FIG. 25, it is conceivable that the total counter value and the life counter value have a relation of direct proportion. Specifically, the relation between the total counter value and the life counter value shown in FIG. 25 is indicated by a life counter value per unit total counter (an LT value). If the LT value is set, the counter converting unit 208 can calculate an estimated value of the life counter value by multiplying the total counter value with the LT value.

For example, in the example shown in FIG. 25, an LT value of a photoconductive drum is “5.1”. In this case, a value obtained by multiplying a total counter value of the photoconductive drum with 5.1 is an estimated value of a life counter value of the photoconductive drum. Specifically, the counter converting unit 208 of the management apparatus 3 calculates a latest life counter estimated value from a latest value of a total counter included in the simplified data acquired from the second MFP 2B and LT values of the consumables.

The relation value (the LT value) indicating the relation between the total counter value (the simplified data) and the life counter value (the data for creating a maintenance schedule) is not limited to a ratio of the total counter value and the life counter value explained above and only has to be a value for allowing the life counter value to be calculated from the total counter value.

In this embodiment, the LT-value calculating unit 204a calculates the relation value (the LT value) indicating the relation between the total counter value and the life counter value and sets the relation value (the LT value) in the counter converting unit 208. The LT-value calculating unit 204a may calculate the LT value every time the spot collection data is input or may read out the spot collection data stored in the storing unit 23 and calculate the LT value when a maintenance schedule is created. If the LT-value calculating unit 204a calculates the LT value every time the spot collection data is input, the LT-value calculating unit 204a only has to store the calculated LT value in the storing unit 23 or the like.

The LT value is a value set in advance. In this case, the LT value is stored in the storing unit 23 or the like. For example, the LT value indicating the relation between the total counter value (the simplified data) and the life counter value (the data for creating a maintenance schedule) may be set for each of models of MFPs. However, if the relation value (the LT value) indicating the relation between the total counter value and the life counter value is affected by operation forms of the MFPs such as a setting environment, the relation value (the LT value) is calculated for each of second MFPs 2B.

FIG. 26 is an example of the spot collection data. In this embodiment, it is assumed that the spot collection date includes data necessary for calculating an LT value. The spot collection data shown in FIG. 26 includes total counter values in plural data acquisition days and cumulative values of life counters for consumables. The spot collection data shown in FIG. 26 is stored in, for example, the nonvolatile memory 153. The spot collection data stored in the nonvolatile memory 153 is output from the output interface 158 according to the operation by the serviceperson P.

In other words, the simplified data periodically transmitted to the management apparatus 3 by the second MFP 2B does not include a life counter value. On the other hand, the spot collection data output from the output interface 158 of the second MFP 2B by human operation of the serviceperson P includes life counter values of the consumables. For example, when the serviceperson P performs maintenance work, the output interface 158 outputs spot collection data (e.g., data including a life counter value equivalent to detailed data) indicating a state in the second MFP 2B. The serviceperson P carries the spot collection data, which is output by the second MFP 2B, to the service center S and inputs the spot collection data to the input interface 24 of the management apparatus 3.

The output interface 158 only has to be an interface that outputs the spot collection data that can be carried to the service center S and input to the management apparatus 3 by the serviceperson P. For example, the output interface 158 may be an interface that prints the spot collection data on paper and outputs the spot collection data. The output interface 158 may be an interface that stores the spot collection data in a locally-connectable storage medium.

A flow of the processing for creating a maintenance schedule for the second MFP 2B is explained below.

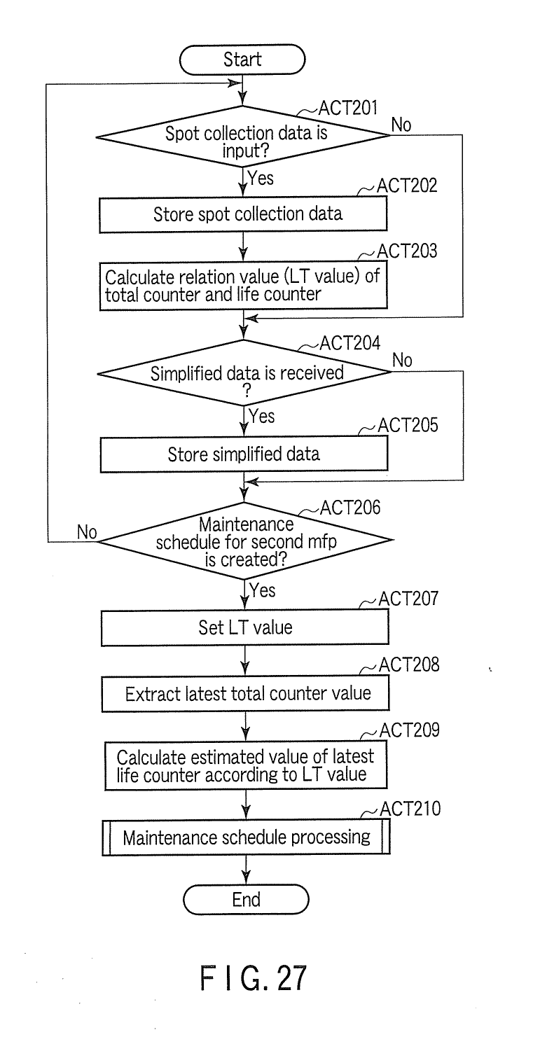

FIG. 27 is a flowchart for explaining the flow of the processing for creating a maintenance schedule for the second MFP 2B.

If spot collection data collected from the second MFP 2B according to the operation by the serviceperson P is input to the input interface 24 (YES in ACT 201), the CPU 20 of the management apparatus 3 stores the input spot collection data in the storing unit 23 (ACT 202). If the spot collection data from the second MFP 2B is stored, the failure-history analyzing unit 204 extracts, for each of the MFPs, a total counter value and a life counter value included in the spot collection data and calculates, with the LT-value calculating unit 204a, an LT value indicating a relation between the total counter value and the life counter value (ACT 203). For example, the storing unit 23 stores the LT value, which is calculated by the LT-value calculating unit 204a, in association with the second MFP 2B.

If simplified data is received from the second MFP 2B by periodic communication via the communication interface 22 (YES in ACT 204), the CPU 20 of the management apparatus 3 stores the received simplified data in the storing unit 23 (ACT 205). If the second MFP 2B for which a maintenance schedule is created is determined (YES in ACT 206), the CPU 20 of the management apparatus 3 sets an LT value corresponding to the second MFP 2B in the counter converting unit 208 (ACT 207).

If the second MFP 2B for which a maintenance schedule is created is determined, the CPU 20 extracts, from the storing unit 23, a latest total counter value included in latest simplified data acquired from the second MFP 2B (ACT 208). If the latest total counter value is extracted, the CPU 20 calculates a latest life counter estimated value with the counter convert unit 208 from the latest total counter value using the LT value corresponding to the second MFP 2B (ACT 209).

If the latest life counter estimated value is calculated by the counter converting unit 208, the CPU 20 creates, with the maintenance scheduling unit 206, a maintenance schedule for the second MFP 2B using the calculated latest life counter estimated value (ACT 210). The maintenance scheduling unit 206 creates a maintenance schedule for the second MFP 2B according to processing same as the processing for creating a maintenance schedule for the first MFP 2A using the estimated value of the life counter calculated by the counter converting unit 208 as a latest life counter value.

With the maintenance scheduling system, even for a MFP for which detailed data representing a state of a machine necessary for optimization of a maintenance schedule cannot be acquired, it is possible to optimize the maintenance schedule by estimating detailed data from simplified data. An efficient visit schedule of a serviceperson is realized. As a result, with the maintenance scheduling system, even in a system including a MFP that notifies a management apparatus of only simplified data, it is possible to reduce cost related to a maintenance job and reduce downtime of a product.

Processing for creating a maintenance schedule for the third digital multifunction peripheral 2 is explained.

As explained above, the management apparatus 3 creates a maintenance schedule for the first MFP 2A or a maintenance schedule for the second MFP 2B on the basis of periodically-received data. However, the third MFP 2C does not include a communication function with the management apparatus 3 via the communication network 10 and does not periodically transmit data to the management apparatus 3.

In other words, since there is no periodic communication from the third MFP 2C, the management apparatus 3 cannot periodically update information indicating the number of times of operation in the third MFP 2C. For example, the management apparatus 3 cannot periodically update a total counter value in the third MFP 2C. However, data acquired from the third MFP 2C according to the operation by the serviceperson P is irregularly input to the management apparatus 3. The data irregularly (for example, at the time of visit to perform the PM or the EM) input by the serviceperson P is, for example, data (spot collection data) equivalent to detailed data. The management apparatus 3 includes a function of estimating a latest total counter value referring to the data irregularly input by the serviceperson P.

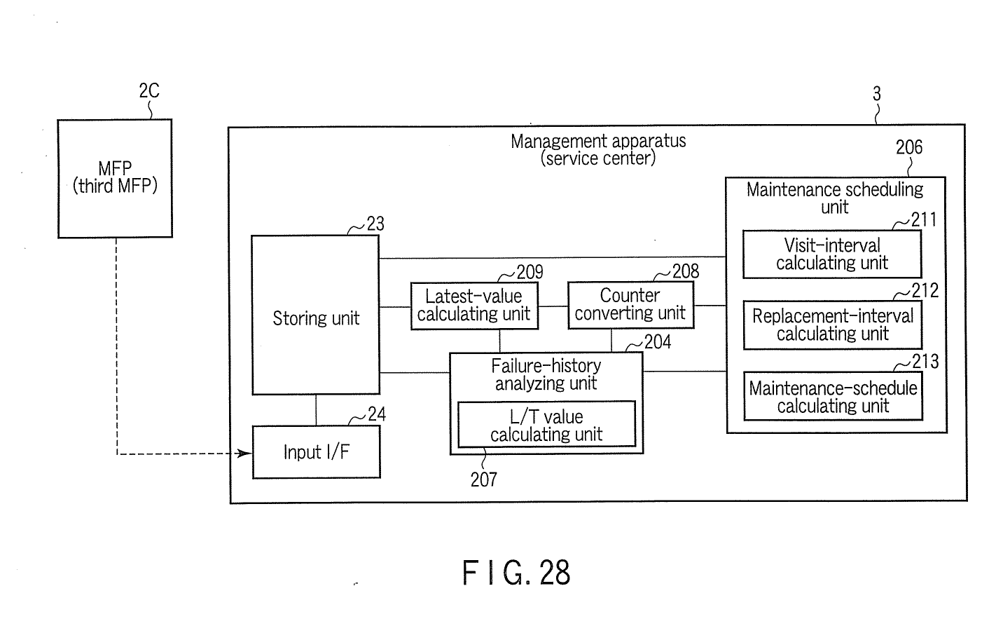

FIG. 28 is a schematic diagram for explaining the processing for creating a maintenance schedule for the third digital multifunction peripheral (MFP) 2C.

The management apparatus 3 creates a maintenance schedule according to spot collection data acquired from the third MFP 2C according to the operation by the serviceperson P. In the system shown in FIG. 28, the management apparatus 3 cannot communicate with the third MFP 2C via the communication network 10. The management apparatus 3 inputs the spot collection data collected from the third MFP 2C according to the operation by the serviceperson P to the input interface 24. The spot collection data includes, for example, data equivalent to detailed data or simplified data. The spot collection data input by the input interface 24 is stored in the storing unit 23.

The failure-history analyzing unit 204 includes the LT-value calculating unit 204a configured to calculate an LT value indicating a relation between a total counter value and life counter values of consumables according to the spot collection data stored in the storing unit 23 and a progress-degree calculating unit 204b configured to calculate a total counter progress degree. The LT-value calculating unit 204a calculates an LT value indicating a relation between the total counter value included in the spot collection data stored in the storing unit 23 and the life counter values of the consumables. The progress-degree calculating unit 204b calculates a total counter value per one day (hereinafter referred to as total counter progress degree) from a relation between a data acquisition day and the total counter value included in the spot collection data stored in the storing unit 23.

The failure-history analyzing unit 204 sets the LT value calculated by the LT-value calculating unit 204a in the counter converting unit 208. The failure-history analyzing unit 204 sets the total counter progress degree calculated by the progress-degree calculating unit 204b in the latest-value calculating unit 209. The latest-value calculating unit 209 extracts the total counter value and the acquisition day included in the spot collection data stored in the storing unit 23 and calculates a latest total counter estimated value according to the extracted data and the total counter progress degree set in the failure-history analyzing unit 204. The latest-value calculating unit 209 supplies the calculated latest total counter estimated value to the counter converting unit 208. The counter converting unit 208 converts the latest total counter estimated value to a latest life counter estimated value according to the LT value set in the failure-history analyzing unit 204.

In other words, the latest-value calculating unit 209 and the counter converting unit 208 a latest life counter value from the total counter value included in the spot collection data using the total counter progress degree and the LT value set in the failure-history analyzing unit 204. The latest total counter estimated value calculated by the latest-value calculating unit 209 and the latest life counter estimated value calculated by the counter converting unit 208 are output to the maintenance scheduling unit 206 as data for creating a maintenance schedule. The maintenance scheduling unit 206 creates, using the latest total counter estimated value calculated by the latest-value calculating unit 209, the latest life counter estimated value calculated by the counter converting unit 208, and the like, a maintenance schedule for the third MFP 2C in the same manner as the creation of the maintenance schedule for the first MFP 2A.

The total counter progress degree may be a value set in advance. In this case, the total counter progress value is stored in the storing unit 23 or the like. For example, the total counter progress degree may be set in advance for each of users. However, like the LT value, the total counter progress degree is considered to be often affected by operation forms of the MFPs such as a purpose of use and a setting environment. Therefore, in this embodiment, the total counter progress degree is calculated for each of the second MFPs 2C.

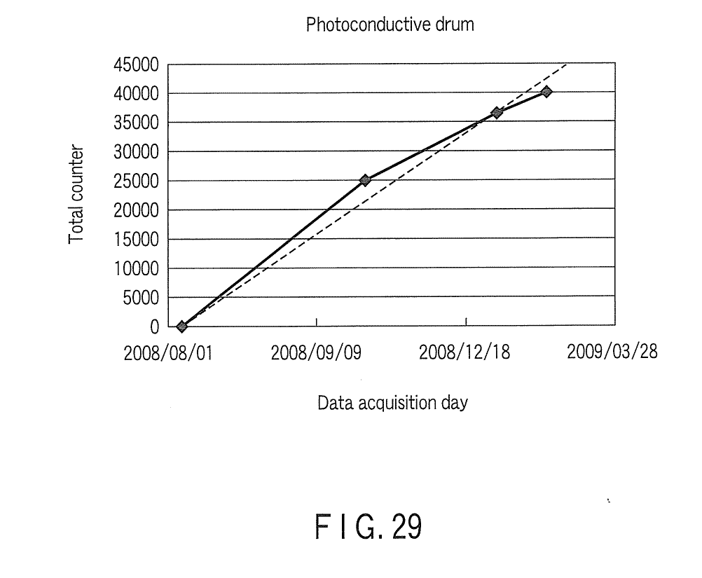

FIG. 29 is a diagram of a relation between a data acquisition day and a total counter value. The failure-history analyzing unit 204 includes the progress-degree calculating unit 204b configured to calculate a total counter progress degree from a data acquisition day and a total counter value included in spot collection data. The progress-degree calculating unit 204b extracts a data acquisition day and a total counter value from the spot collection data stored in the storing unit 23, analyzes a relation between the data acquisition day and the total counter value shown in FIG. 29, and calculates a total counter value per one day (hereinafter referred to as total counter progress degree). For example, in an example shown in FIG. 29, the total counter progress degree is 162. In this case, a present total counter estimated value (a latest total counter value) is calculated by adding a value obtained by multiplying the number of elapsed days with 162 to a total counter value acquired last.

A flow of the processing for creating a maintenance schedule for the third MFP 2C is explained below.

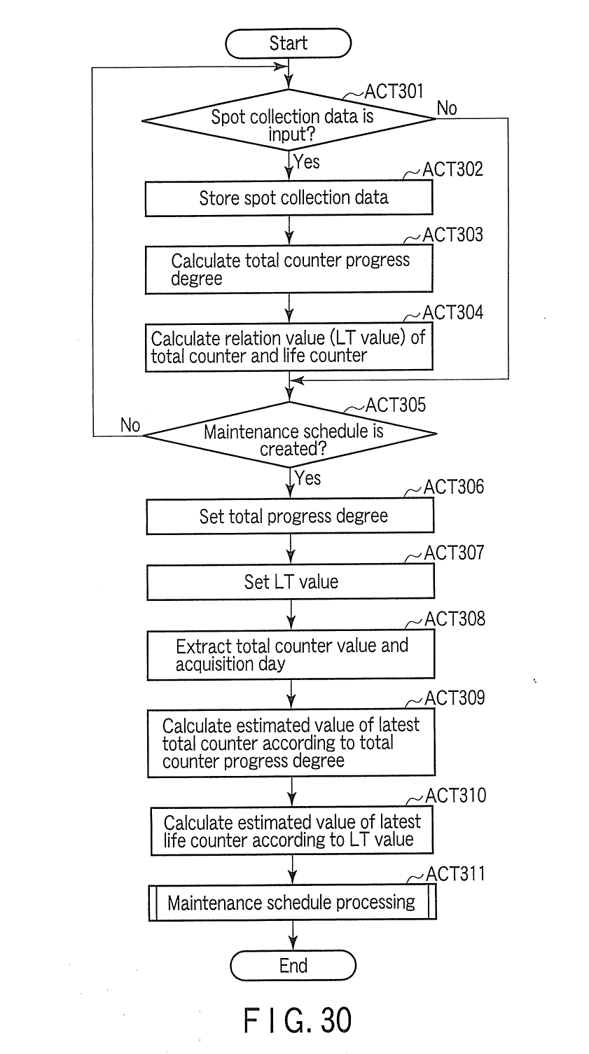

FIG. 30 is a flowchart for explaining the flow of the processing for creating a maintenance schedule for the third MFP 2C.

If spot collection data collected from the third MFP 2C according to the operation by the serviceperson P is input to the input interface 24 (YES in ACT 301), the CPU 20 of the management apparatus 3 stores the input spot collection data in the storing unit 23 (ACT 302). If the spot collection data from the third MFP 2C is stored, the CPU 20 extracts total counter values acquired in the past and acquisition days of the total counter values from the third MFP 2C according to the spot collection data stored in the storing unit 23 and calculates, with the progress-degree calculating unit 204b of the failure-history analyzing unit 204, a total counter progress degree as a total counter value per one day (ACT 303). In this case, the storing unit 23 stores the total counter progress degree calculated by the progress-degree calculating unit 204b in association with information (e.g., a machine ID) indicating the third MFP 2C.

Further, if the spot collection data from the third MFP 2C is stored, the CPU 20 extracts total counter values and life counter values acquired in the past from the third MFP 2C according to the spot collection data stored in the storing unit 23 and calculates an LT value with the LT-value calculating unit 204a of the failure-history analyzing unit 204 (ACT 304). In this case, the storing unit 23 stores the LT value calculated by the LT-value calculating unit 204a in association with information (e.g., a machine ID) indicating the third MFP 2C.

The processing in ACT 303 and the processing in ACT 304 may be executed after it is determined that a maintenance schedule is created (YES in ACT 305). Specifically, after a MFP for which a maintenance schedule should be created is determined, the CPU 20 may execute the processing in ACT 303 by the progress-degree calculating unit 204b and the processing in ACT 304 by the LT-value calculating unit 204a and calculate a total counter progress degree and an LT value.

If the third MFP 2C for which a maintenance schedule is created is determined (YES in ACT 305), the CPU 20 sets a total counter progress degree corresponding to the third MFP 2C in the latest-value calculating unit 209 (ACT 306) and sets an LT value corresponding to the third MFP 2 in the counter converting unit 208 (ACT 307).

If the third MFP 2C for which a maintenance schedule is created is determined, the CPU 20 extracts, from the storing unit 23, the total counter values in the past and the acquisition days of the total counter values included in the spot collection data acquired from the third MFP 2C (ACT 308). If the total counter values and the acquisition days are extracted, the CPU 20 calculates, with the latest-value calculating unit 209, a present (latest) total counter estimated value from the total counter values in the past and the acquisition days using the total counter progress degree corresponding to the third MFP 2C (ACT 309).

If the total counter estimated value as the latest total counter value is calculated, the CPU 20 calculates, with the counter converting unit 208, a latest life counter estimated value from the latest total counter estimated value calculated by the latest-value calculating unit 209 using the LT value corresponding to the third MFP 2C (ACT 310). The CPU 20 creates, with the maintenance scheduling unit 206, a maintenance schedule for the third MFP 2C using the latest total counter estimated value calculated by the latest-value calculating unit 209 and the latest life counter estimated value calculated by the counter converting unit 208 (ACT 311). The maintenance scheduling unit 206 sets the total counter estimated value calculated by the latest-value calculating unit 209 as a latest total counter value, sets the life counter estimated value calculated by the counter converting unit 208 as a latest life counter value, and creates a maintenance schedule for the third MFP 2C according to processing same as the processing for creating a maintenance schedule for the first MFP 2A.

With the maintenance scheduling system, even for a MFP with which a management apparatus cannot perform data communication via a communication line, it is possible to optimize a maintenance schedule by estimating detailed data representing a state of a machine necessary for optimization of the maintenance schedule from spot collection data collected by human operation. An efficient visit schedule of a serviceperson is realized. As a result, with the maintenance scheduling system, even in a system including a MFP that does not include a communication function with the management apparatus, it is possible to reduce cost related to a maintenance job and reduce downtime of a product.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management apparatus comprising:
a setting unit configured to set a relation value indicating a relation between a number of operations in an image processing apparatus to be subjected to maintenance scheduling and data indicating a life of a consumable in the image processing apparatus;
a data converting unit configured to convert, using the relation value, the number of operations acquired from the image processing apparatus into the data indicating the life of the consumable in the image processing apparatus; and
a maintenance scheduling unit configured to create a maintenance schedule for the image processing apparatus using the data indicating the life of the consumable in the image processing apparatus calculated by the data converting unit.

2. The apparatus according to claim 1, further comprising:
an input interface configured to input numbers of operations and data indicating lives of consumables in a past in the image processing apparatus; and
a relation-value calculating unit configured to calculate the relation value according to the numbers of operations and the data indicating the lives of the consumables in the past in the image processing apparatus input by the input interface.

3. The apparatus according to claim 1, further comprising a receiving unit configured to receive simplified data including the number of operations of the image processing apparatus from the image processing apparatus via a communication line, wherein
the data converting unit converts the simplified data received from the image processing apparatus by the receiving unit into the data indicating the life of the consumable in the image processing apparatus using the relation value.

4. The apparatus according to claim 1, wherein the number of operations of the image processing apparatus is a total counter value indicating a number of times the image processing apparatus forms images on image formation media.

5. The apparatus according to claim 4, wherein
the data indicating the life of the consumable is a life counter value of the consumable, and
the relation value is a value indicating a relation between the total counter value and the life counter value of the consumable in the image processing apparatus.

6. The apparatus according to claim 5, wherein the relation value is a ratio of the total counter value and the life counter value.

7. The apparatus according to claim 5, wherein the life counter value is a counter value corresponding to a physical amount having a high correlation with a degree of deterioration of the consumable in the image processing apparatus.

8. The apparatus according to claim 1, further comprising:
an input interface configured to input numbers of operations and acquisition dates of the numbers of operations in a past in the image processing apparatus; and
a latest-value calculating unit configured to calculate a present estimated value of a number of operations in the image processing apparatus from the numbers of operations in the past of the image processing apparatus using a progress degree of the number of operations in the image processing apparatus, wherein
the data converting unit calculates the data of the life of the consumable in the image processing apparatus from the present estimated value of the number of operations calculated by the latest-value calculating unit using the relation value.

9. The apparatus according to claim 8, wherein
the input interface inputs numbers of operations and data indicating lives of consumables in a past in the image processing apparatus, and
the apparatus further comprises a relation-value calculating unit configured to calculate the relation value according to the numbers of operations and the data indicating the lives of the consumables in the past in the image processing apparatus input by the input interface.

10. The apparatus according to claim 9, wherein
the data indicating the life of the consumable is a life counter value of the consumable, and
the relation value is a value indicating the total counter value and the life counter value of the consumable in the image processing apparatus.

11. The apparatus according to claim 10, wherein the relation value is a value indicating a ratio of the total counter value and the life counter value.

12. The apparatus according to claim 10, wherein the life counter value is a counter value corresponding to a physical amount having a high correlation with a degree of deterioration of the consumable in the image processing apparatus.

13. A maintenance scheduling system comprises a management apparatus and an image processing apparatus,
the management apparatus comprising:
a setting unit configured to set a relation value indicating a relation between a number of operations in the image processing apparatus and data indicating a life of a consumable in the image processing apparatus;
a data converting unit configured to convert, using the relation value, the number of operations acquired from the image processing apparatus into the data indicating the life of the consumable in the image processing apparatus; and
a maintenance scheduling unit configured to create a maintenance schedule for the image processing apparatus using the data indicating the life of the consumable in the image processing apparatus calculated by the data converting unit, and
the image processing apparatus comprising:
a data storing unit configured to store the number of operations and the data indicating the life of the consumable in the apparatus, and
an output interface configured to output the number of operations and the data indicating the life of the consumable stored in the data storing unit.

14. The system according to claim 13, wherein
the management apparatus further comprising:
an input interface configured to input numbers of operations and data indicating lives of consumables in a past in the image processing apparatus; and
a relation-value calculating unit configured to calculate the relation value according to the numbers of operations and the data indicating the lives of the consumables in the past in the image processing apparatus input by the input interface.

15. The system according to claim 13, wherein
the image processing apparatus further comprising:
a transmitting unit configured to transmit simplified data including the number of operations and not including the data indicating the life of the consumable to the management apparatus via a communication line,
the management apparatus further comprising:
a receiving unit configured to receive the simplified data from the image processing apparatus, and
the data converting unit converts the simplified data received by the receiving unit into the data indicating the life of the consumable in the image processing apparatus using the relation value.

16. The system according to claim 13, wherein
the management apparatus further comprising:
an input interface configured to input, numbers of operations and acquisition dates of the numbers of operations in a past in the image processing apparatus; and
a latest-value calculating unit configured to calculate a present estimated value of a number of operations in the image processing apparatus from the numbers of operations in the past of the image processing apparatus using a progress degree of the number of operations in the image processing apparatus, wherein
the data converting unit calculates the data of the life of the consumable in the image processing apparatus from the present estimated value of the number of operations calculated by the latest-value calculating unit using the relation value.

17. A method of creating a maintenance schedule for an image processing apparatus, the method comprising:
setting a relation value indicating a relation between a number of operations in an image processing apparatus to be subjected to maintenance scheduling and data indicating a life of a consumable in the image processing apparatus;
converting, using the relation value, the number of operations acquired from the image processing apparatus into the data indicating the life of the consumable in the image processing apparatus; and
creating a maintenance schedule for the image processing apparatus using the data indicating the life of the consumable in the image processing apparatus calculated by the data conversion.

18. The method according to claim 17, further comprising:
inputting numbers of operations and data indicating lives of consumables in a past in the image processing apparatus; and
calculating the relation value according to the input numbers of operations and the input data indicating the lives of the consumables in the past in the image processing apparatus.

19. The method according to claim 17, further comprising receiving simplified data including the number of operations of the image processing apparatus from the image processing apparatus via a communication line, wherein
the data conversion includes converting the simplified data received from the image processing apparatus into the data indicating the life of the consumable in the image processing apparatus using the relation value.

20. The method according to claim 17, further comprising:
inputting numbers of operations and acquisition dates of the numbers of operations in a past in the image processing apparatus; and
calculating a present estimated value of a number of operations in the image processing apparatus from the numbers of operations in the past of the image processing apparatus using a progress degree of the number of operations in the image processing apparatus, wherein
the data conversion includes calculating the data of the life of the consumable in the image processing apparatus from the calculated present estimated value of the number of operations using the relation value.
